(19) United States
(12) Patent Application Publication
(10) Pub. No.: US 2024/0103506 A1
(43) Pub. Date: Mar. 28, 2024

(54) METHODS, APPARATUS, AND ARTICLES OF MANUFACTURE TO IDENTIFY CAUSES OF DEFECTS IN INDUSTRIAL ENVIRONMENTS

(71) Applicant: Intel Corporation, Santa Clara, CA (US)

(72) Inventors: Priyanka Mudgal, Portland, OR (US); Mark Yarvis, Portland, OR (US); Rita H. Wouhaybi, Portland, OR (US)

(21) Appl. No.: 18/531,476

(22) Filed: Dec. 6, 2023

(51) Int. Cl. G05B 23/02

(52) U.S. Cl. CPC G05B 23/0221

(57) ABSTRACT

Systems, apparatus, articles of manufacture, and methods are disclosed to identify causes of defects in industrial environments. An example apparatus includes interface circuitry to access data associated with an object in an environment and programmable circuitry to utilize machine-readable instructions. For example, the programmable circuitry is to identify a cause of a defect of the object based on a timeline of the object in the environment, the timeline based on the data.

### FIELD OF THE DISCLOSURE

This disclosure relates generally to industrial systems and, more particularly, to methods, apparatus, and articles of manufacture to identify causes of defects in industrial environments.

### BACKGROUND

Industrial facilities (e.g., warehouses, manufacturing facilities, cold storage facilities, showrooms, data centers, research and development facilities, shipyards, docks, distribution centers, etc.) are complex facilities that utilize technologies to manage processes occurring at the industrial facilities. For example, a warehouse manager may utilize a warehouse management system (WMS) to support inventory management, location control, analyze capacity and/or stock levels, and evaluate employee efficiency. Additionally or alternatively, a manager of a manufacturing facility may utilize a manufacturing process management (MPM) system to perform production process planning, computer-aided manufacturing, generation of shop floor work instructions, time and cost estimates, quality computer-aided quality assurance, and/or success measurements.

### BRIEF DESCRIPTION OF THE DRAWINGS

FIG. 1 is an illustration of an example edge network environment including an example edge gateway and an example edge switch that may implement an example defect analysis system.

FIG. 2 is a block diagram of an example implementation of the defect analysis system of FIG. 1.

FIG. 3 illustrates an overview of an Edge cloud configuration for Edge computing.

FIG. 4 illustrates operational layers among endpoints, an Edge cloud, and cloud computing environments.

FIG. 5 illustrates an example approach for networking and services in an Edge computing system.

FIG. 6 is a flowchart representative of example machine-readable instructions and/or example operations that may be executed, instantiated, and/or performed by example programmable circuitry to implement the defect analysis system of FIG. 2 to generate a defect-aware timeline for an object.

FIG. 7 is a flowchart representative of example machine-readable instructions and/or example operations that may be executed, instantiated, and/or performed by example programmable circuitry to implement the defect analysis system of FIG. 2 to allocate an event to a cluster.

FIG. 8 is a flowchart representative of example machine-readable instructions and/or example operations that may be executed, instantiated, and/or performed by example programmable circuitry to implement the defect analysis system of FIG. 2 to identify a cause of a defect to an object.

FIG. 9 is a block diagram of an example processing platform including programmable circuitry structured to execute, instantiate, and/or perform the example machine-readable instructions and/or perform the example operations of FIGS. 6, 7, and/or 8 to implement the defect analysis system of FIG. 2.

FIG. 10 is a block diagram of an example implementation of the programmable circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine-readable instructions of FIGS. 6, 7, and/or 8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

In manufacturing, supply chain, and/or warehouses, identifying defective objects is beneficial. For example, in warehouse environments, it is possible for several packages (e.g., cardboard boxes) to have defects. In a warehouse environment, defects can result from objects being received in a defective state, wear and tear, and/or handling of the objects by manual and/or automated process. For example, if a forklift and/or a conveyor belt has a sharp point, the forklift and/or the conveyor belt may damage all the boxes that the forklift picks up and/or that interact with the conveyor belt. Additionally, for example, if the location of a box pickup is outdoors, water may accumulate and damage packages on rainy days.

In such examples, many defects will be similar in nature and have a similar cause. In other examples, determining the cause of a defect may be more difficult. For example, if a defect occurs due to improper handling, stacking, or bumping of an object, it may be difficult to determine the cause of a defect. There are numerous (e.g., hundreds, thousands, etc.) problems that exist in industrial facilities and can cause defects to objects. Such defects result in loss of business, reduced efficiency, and/or product loss.

As such, by identifying the cause (e.g., root cause) of a defect, a manager of an industrial facility can remediate the cause to prevent further defects from occurring. For example, if the root cause of a defect can be identified, then one or more measures can be taken to prevent future damage and overall improvement of an industrial system (e.g., a supply chain). Examples disclosed herein identify when a defect occurred (e.g., on receipt, during storage, during handling, etc.) in an industrial system (e.g., to establish responsibility) and correlate many occurrences of similar defects to identify common causes (e.g., to reduce future risk).

For example, methods, apparatus, and articles of manufacture disclosed herein track the path and/or history of an object (e.g., a package). For example, a path and/or history of an object indicates where the object travelled from, what route the object travelled along, which equipment was used to handle the object, the environment and/or climate the object was exposed to, workers and/or machines that interacted with the object, time of delivery of the object, time of dispatch of the object, among others. Examples disclosed herein cluster data based on category of defects created and identify the correlation of a defect of an object based on lifetime events experienced by the object.

Examples disclosed herein create a timeline of metadata and/or object characteristics. As such, example identification of a cause of a defect can be achieved via statistical analysis of defects to objects and associated metadata of the objects and identifying possible causes of a defect based on a timeline generated from the metadata. For example, if packages are routinely damaged on corners, then examples disclosed herein track metadata associated with a package and identify if the package is being handled by a process that might involve a damaged system and/or machine.

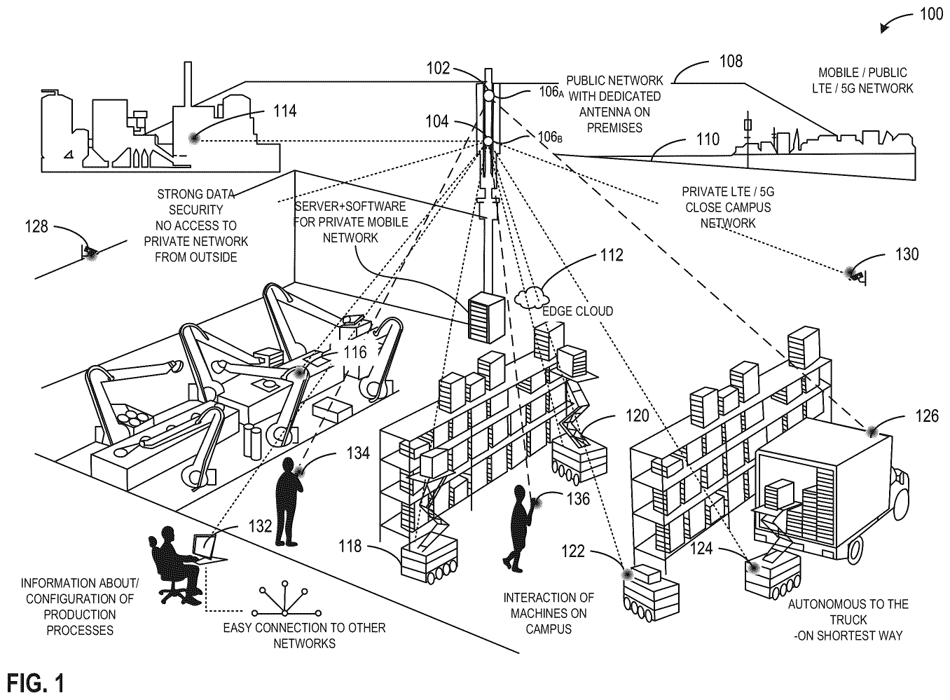

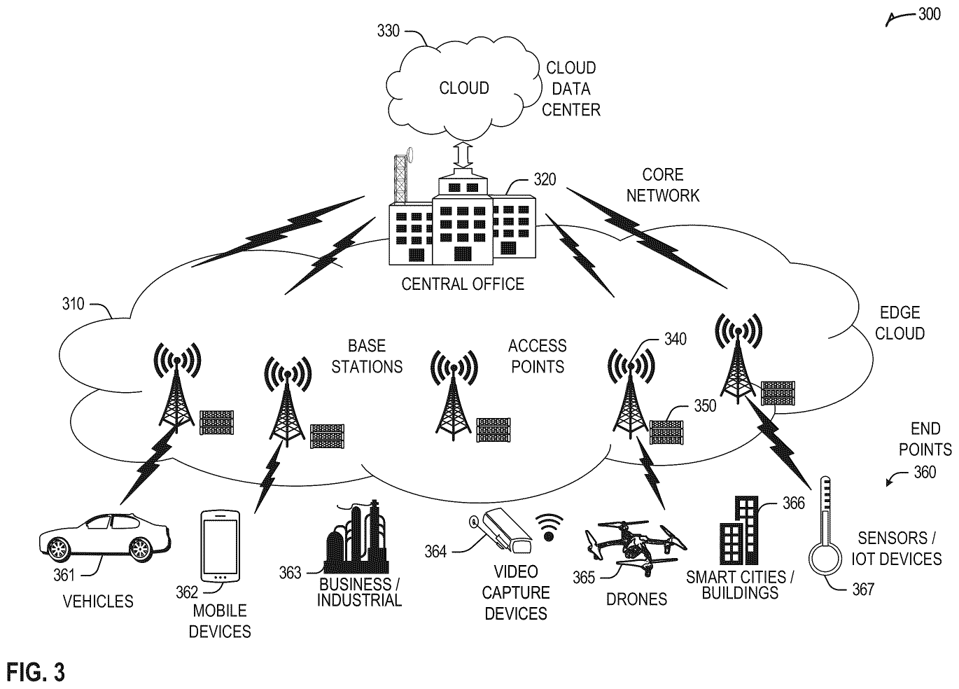

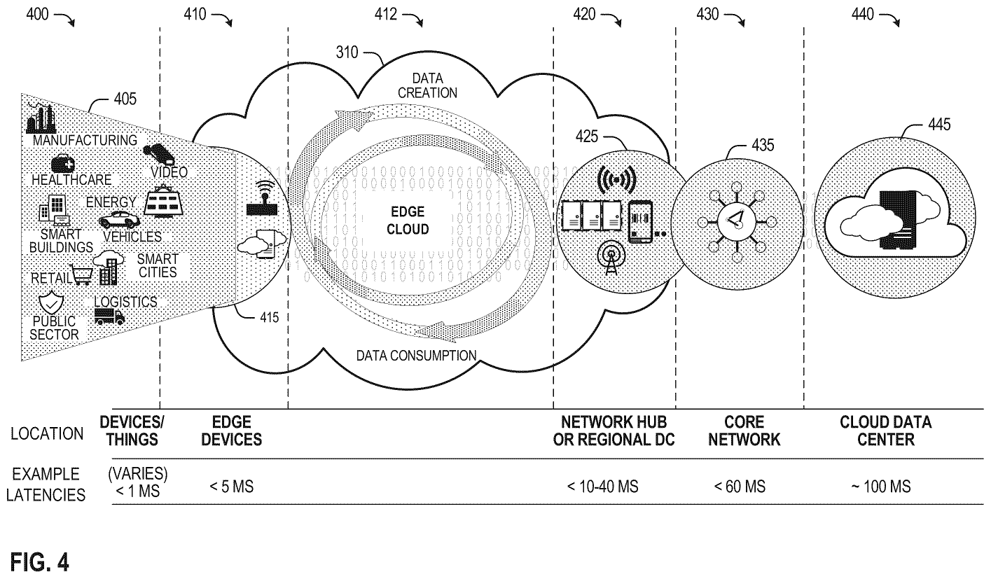

FIG. 1 is an illustration of an example edge network environment 100 including an example edge gateway 102 and an example edge switch 104 that may implement an example defect analysis system 106. For example, the edge gateway 102 implements an example first defect analysis system 106_{A} and an example second defect analysis system 106_{B}. In some examples, the edge gateway 102 and/or the edge switch 104 may implement resources of the edge devices layer 410 of FIG. 4. In some examples the edge gateway 102 and/or the edge switch 104 may implement the access point or base station 340 of FIG. 3, the local processing hub 350 of FIG. 3, and/or the nodes 415 of FIG. 4. For example, the edge gateway 102 and/or the edge switch 104 may implement the edge devices layer 410 of FIG. 4. In some examples, there are a plurality of the edge gateways 102 and/or a plurality of the edge switches 104 in the edge network environment 100. The defect analysis system 106 of the edge gateways 102 and/or the edge switches 104 may be executed in multiple places of the edge network environment 100 (e.g., by ones of the edge gateways 102, the edge switches 104, etc., or any other device(s)).

The edge network environment 100 of the illustrated example includes an example public network 108, an example private network 110, and an example edge cloud 112. In this example, the public network 108 may implement a telephone service provider (TSP) network (e.g., a Long-Term Evolution (LTE) network, a 5G network, a Telco network, etc.). For example, the public network 108 may implement the network access layer 420 of FIG. 4, the core network 430 of FIG. 4, and/or the cloud data center layer 440 of FIG. 4. In this example, the private network 110 may implement an enterprise network (e.g., a close campus network, a private LTE network, a private 5G network, etc.). For example, the private network 110 may implement the endpoint layer 400 of FIG. 4 and/or the edge devices layer 410 of FIG. 4. In some examples, the edge cloud 112 may be implemented by one or more hardware, software, and/or firmware resources. For example, the edge cloud 112 may be implemented by one or more computer servers. In this example, the edge cloud 112 may implement an enterprise edge cloud. For example, the edge cloud 112 may implement the edge cloud 310 of FIGS. 3, 4, and/or 5.

In the illustrated example of FIG. 1, the edge network environment 100 may implement a warehouse (e.g., a fulfillment center), a smart factory (e.g., a smart industrial factory), a process control environment, etc. For example, the edge network environment 100 may implement one(s) of the computational use cases 405 of FIG. 4, such as a manufacturing, smart building, logistics, vehicle, and/or video computational use cases.

The edge network environment 100 of the illustrated example includes an example process control system 114, example robots 116 (e.g., collaborative robots, robot arms, etc.), a first example industrial machine 118 (e.g., an autonomous industrial machine), a second example industrial machine 120, a third example industrial machine 122, a fourth example industrial machine 124, an example vehicle 126 (e.g., a truck, an autonomous truck, an autonomous vehicle, etc.), a first example monitoring sensor 128, a second example monitoring sensor 130, and example endpoint devices 132, 134, 136. In some examples, the process control system 114 may include one or more industrial machines such as a silo, a smokestack, a conveyor belt, a mixer, a pump, etc., and/or a combination thereof. For example, the process control system 114 may implement the business and industrial equipment 363 of FIG. 3, the smart cities and building devices 366 of FIG. 3, etc.

In some examples, the robots 116 may implement hydraulic and/or electromechanical robots that may be configured to execute manufacturing tasks (e.g., lifting equipment, assembling components, etc.), industrial tasks, etc. For example, the robots 116 may implement the business and industrial equipment 363 of FIG. 3, the smart cities and building devices 366 of FIG. 3, etc. In some examples, the industrial machines 116, 118, 120, 122 are autonomous machines, such as autonomous guided vehicles (AGVs), autonomous forklifts, scissor lifts, etc. For example, the industrial machines 118, 120, 122 may implement the business and industrial equipment 363 of FIG. 3, the drones 365 of FIG. 3, the smart cities and building devices 366 of FIG. 3, etc.

In some examples, the vehicle 126 may implement one of the autonomous vehicles 361 of FIG. 3. In some examples, the first monitoring sensor 128 and/or the second monitoring sensor 130 are video cameras. For example, the first monitoring sensor 128 and/or the second monitoring sensor 130 may implement the business and industrial equipment 363 of FIG. 3, the video capture devices 364 of FIG. 3, the smart cities and building devices 366 of FIG. 3, the sensors and IoT devices 367 of FIG. 3, etc. Alternatively, the first monitoring sensor 128 and/or the second monitoring sensor 130 may implement a thermal camera (e.g., an infrared camera), an air pollution sensor, a carbon dioxide sensor, a temperature sensor, a humidity sensor, an air pressure sensor, etc., or any other type of sensor.

In this example, the endpoint devices 132, 134, 136 include a first example endpoint device 132, a second example endpoint device 134, and a third example endpoint device 136. In some examples, one(s) of the endpoint devices 132, 134, 136 may implement consumer computing devices, user equipment, etc. For example, one or more of the endpoint devices 132, 134, 136 may implement the user equipment 362 of FIG. 3. In some examples, one or more of the endpoint devices 132, 134, 136 may be implemented by a smartphone, a tablet computer, a desktop computer, a laptop computer, a wearable device (e.g., a headset or headset display, an augmented reality (AR) headset, a smartwatch, smart glasses, etc.), etc.

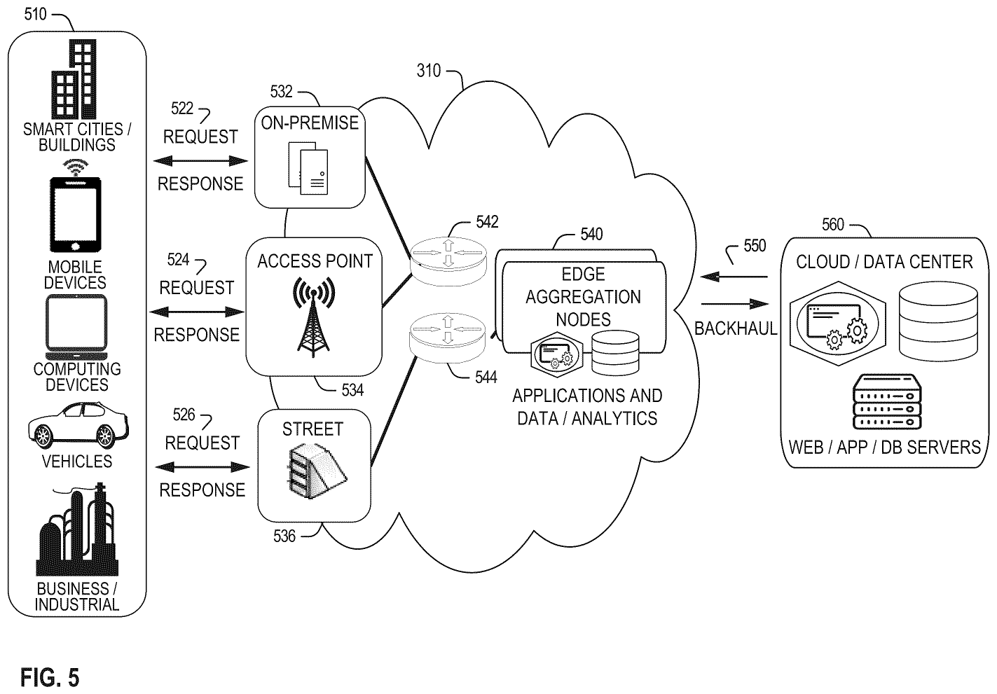

In the illustrated example of FIG. 1, the edge gateway 102 may facilitate communication, data transfers, etc., between different networks, such as communication from a source service, a source appliance, etc., of the public network 108 to a target service, a target appliance, etc., of the private network 110. For example, the edge gateway 102 may receive a data stream including one or more data packets from a source (e.g., a data source), a producer (e.g., a data producer), etc. In some examples, the edge gateway 102 may receive the data stream from the vehicle 126, the second endpoint device 134, the third endpoint device 136, etc., to be transmitted to a target service, a target appliance, etc., which may be implemented by the cloud data center 330 of FIG. 3, the cloud data center 445 of FIG. 4, the cloud or data center 560 of FIG. 5, etc.

In some examples, the edge gateway 102 may facilitate communication, data transfers, etc., between a source service, a source appliance, etc., of the private network 110 to a target service, a target appliance, etc., of the public network 108. For example, the edge gateway 102 may receive a data stream including one or more data packets from a source (e.g., a data source), a producer (e.g., a data producer), etc., which may be implemented by the cloud data center 330 of FIG. 3, the cloud data center 445 of FIG. 4, the cloud or data center 560 of FIG. 5, etc. In some examples, the edge gateway 102 may receive the data stream from the cloud data center 330 of FIG. 3, the cloud data center 445 of FIG. 4, the cloud or data center 560 of FIG. 5, etc., to be transmitted to the vehicle 126, the second endpoint device 134, the third endpoint device 136, etc.

In the illustrated example of FIG. 1, the edge switch 104 may facilitate communication, data transfers, etc., between different sources and targets within a network, such as communication from a source service, a source appliance, etc., of the private network 110 to a target service, a target appliance, etc., of the private network 110. For example, the edge switch 104 may receive a data stream from the edge gateway 102, the edge cloud 112, the process control system 114, one(s) of the robots 116, one(s) of the industrial machines 118, 120, 122, 124, the first monitoring sensor 128, the second monitoring sensor 130, the first endpoint device 132, the second endpoint device 134, the third endpoint device 136, etc. In some examples, the edge switch 104 may transmit the data stream to a destination within the private network 110. For example, the edge switch 104 may transmit the data stream to at least one of the edge gateway 102, the edge cloud 112, the process control system 114, one(s) of the robots 116, one(s) of the industrial machines 118, 120, 122, 124, the vehicle 126, the first monitoring sensor 128, the second monitoring sensor 130, the first endpoint device 132, the second endpoint device 134, or the third endpoint device 136.

In some examples, the edge network environment 100 may implement a large number and/or different types of applications, such as machine vision applications implemented by the robots 116, autonomous driving applications implemented by the vehicle 126, etc. In some examples, the data generated by the private network 110 is relatively diverse because of the vast range of data sources, such as sensors, controllers, services, and/or user input that may be processed and analyzed to identify anomalies and trends in the data. For example, the edge gateway 102 and/or the edge switch 104 may facilitate the transmission of data including sensor data or measurements, video feeds, still images, predictive maintenance alerts or control commands, robotic control commands, etc., and/or a combination thereof.

In the illustrated example of FIG. 1, the defect analysis system 106 of the edge gateway 102 and/or the edge switch 104 provides a holistic view of defects detected in the edge network environment 100 and tracks the defects across multiple sensor streams over time. For example, the defect analysis system 106 of the edge gateway 102 and/or the edge switch 104 tracks an object over time and space, identifies a source of a defect, and provides a user with a view of available sensor data relevant to a defective object, even when a given sensor input cannot observe the defect. Additionally, the defect analysis system 106 of the edge gateway 102 and/or the edge switch 104 provides implicit sensor data collection to facilitate root cause analysis of defects detected in the edge network environment 100.

Additionally, the defect analysis system 106 of the edge gateway 102 and/or the edge switch 104 correlates two or more events and analyzes the resulting costs of defects that may be caused by the events. Thus, the defect analysis system 106 of the edge gateway 102 and/or the edge switch 104 identifies sources of risk in the edge network environment 100 and determines adjustment to industrial processes (e.g., a process control system including one or more industrial machines such as a silo, a smokestack, a conveyor belt, a mixer, a pump, etc., and/or a combination thereof) to improve the industrial processes. For example, the defect analysis system 106 of the edge gateway 102 and/or the edge switch 104 proactively identifies damaged equipment and/or damaging conditions in the edge network environment 100 and alerts management of and/or causes remediation of the damaged equipment and/or damaging conditions.

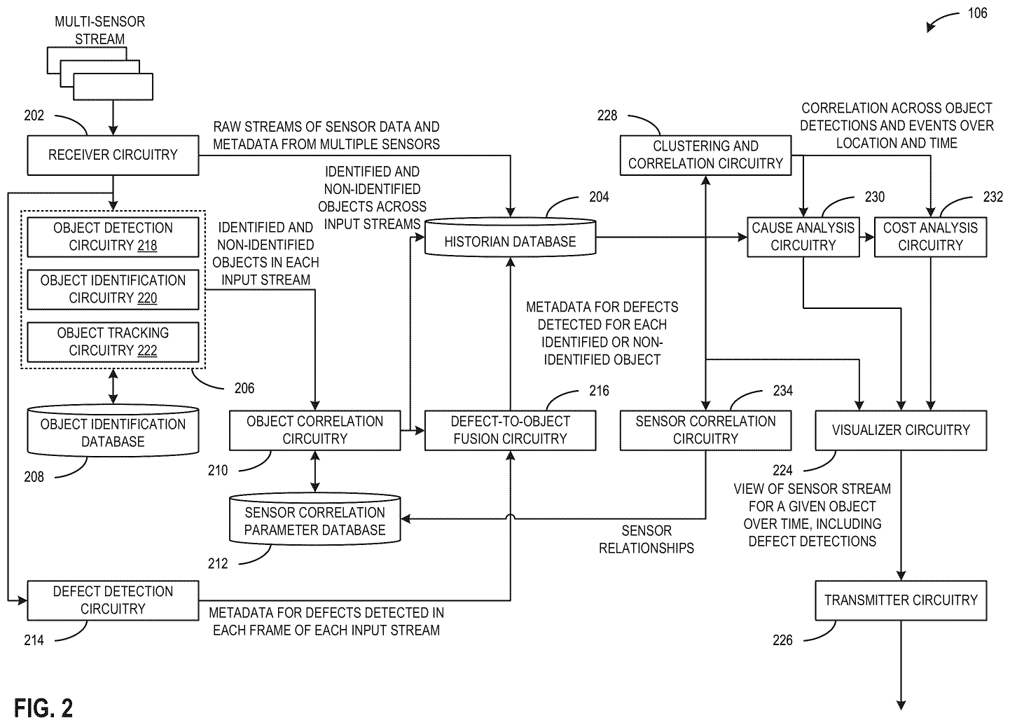

FIG. 2 is a block diagram of an example implementation of the defect analysis system 106 of FIG. 1 to determine causes of defects to objects in the edge network environment 100 of FIG. 1. The defect analysis system 106 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the defect analysis system 106 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

In the illustrated example of FIG. 2, the defect analysis system 106 includes example receiver circuitry 202, an example historian database 204, example object monitoring circuitry 206, an example object identification database 208, example object correlation circuitry 210, an example sensor correlation parameter database 212, example defect detection circuitry 214, and example defect-to-object fusion circuitry 216. In the example of FIG. 2, the object monitoring circuitry 206 includes example object detection circuitry 218, example object identification circuitry 220, and example object tracking circuitry 222. Additionally, the defect analysis system 106 includes example visualizer circuitry 224, example transmitter circuitry 226, example clustering and correlation circuitry 228, example cause analysis circuitry 230, example cost analysis circuitry 232, and example sensor correlation circuitry 234.

In the illustrated example of FIG. 2, the receiver circuitry 202 is in communication with one or more sensors of the edge network environment 100 of FIG. 1. For example, the receiver circuitry 202 is in communication with the first monitoring sensor 128 and/or the second monitoring sensor 130 of FIG. 1. Additionally, the receiver circuitry 202 is in communication with the historian database 204, the object monitoring circuitry 206, and the defect detection circuitry 214. In the example of FIG. 2, the receiver circuitry 202 accesses one or more streams of sensor data and metadata from one or more sensors of the edge network environment 100 of FIG. 1.

In the illustrated example of FIG. 2, the receiver circuitry 202 forwards accessed streams of sensor data and metadata to the historian database 204, the object monitoring circuitry 206, and the defect detection circuitry 214. Example sensor data includes video data from a video camera, audio data from a microphone, radio frequency identifier (RFID) data from an RFID reader, barcode data from a barcode scanner, and/or data from any other device for sensing objects and/or people in the edge network environment 100 of FIG. 1. Example metadata includes timestamps, sensor location, sensor orientation, etc.

In the illustrated example of FIG. 2, the historian database 204 is in communication with the receiver circuitry 202, the object correlation circuitry 210, the defect-to-object fusion circuitry 216, the visualizer circuitry 224, the clustering and correlation circuitry 228, and the sensor correlation circuitry 234. In the example of FIG. 2, the historian database 204 records data (e.g., input streams of sensor data and metadata, correlated object detections, defect detections, timelines of objects, defect-aware timelines of objects, etc.). In the example of FIG. 2, the historian database 204 may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The historian database 204 may additionally or alternatively be implemented by one or more double data rate (DDR) memories, such as DDR, DDR2, DDR3, DDR4, DDR5, mobile DDR (mDDR), DDR SDRAM, etc.

In the illustrated example of FIG. 2, the historian database 204 may additionally or alternatively be implemented by one or more mass storage devices such as hard disk drive(s) (HDD(s)), compact disk (CD) drive(s), digital versatile disk (DVD) drive(s), solid-state disk (SSD) drive(s), Secure Digital (SD) card(s), CompactFlash (CF) card(s), etc. While in the illustrated example the historian database 204 is illustrated as a single database, the historian database 204 may be implemented by any number and/or type(s) of databases. For example, the historian database 204 may be implemented as a distributed database with one or more indices that allow for queries to be directed to the physical storage location of the data. Furthermore, the data stored in the historian database 204 may be in any data format such as, for example, binary data, comma delimited data, tab delimited data, structured query language (SQL) structures, etc.

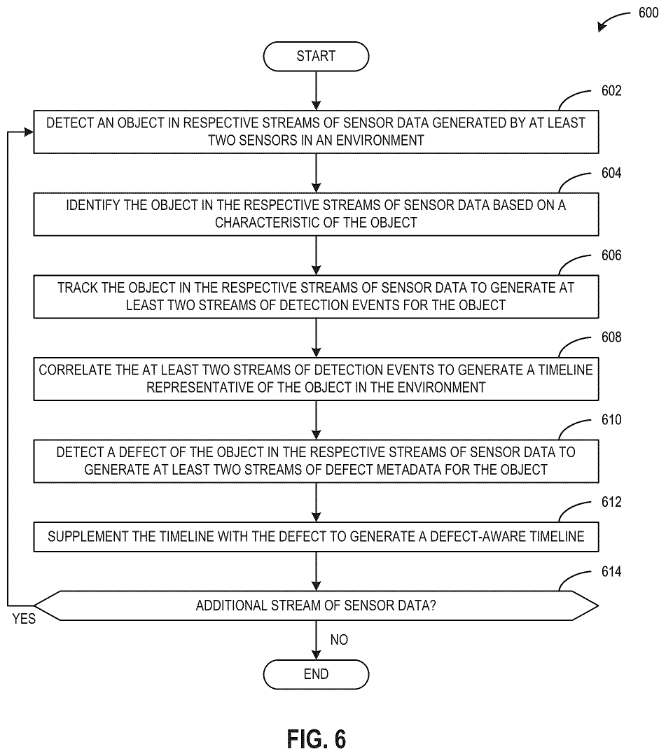

In the illustrated example of FIG. 2, the object monitoring circuitry 206 is in communication with the receiver circuitry 202, the object identification database 208, and the object correlation circuitry 210. In the example of FIG. 2, the object monitoring circuitry 206 includes the object detection circuitry 218, the object identification circuitry 220, and the object tracking circuitry 222 to detect, identify, and track objects over time in each stream of sensor data and metadata. In some examples, the object monitoring circuitry 206 is instantiated by programmable circuitry executing object monitoring instructions and/or configured to perform operations such as those represented by the flowchart of FIG. 6.

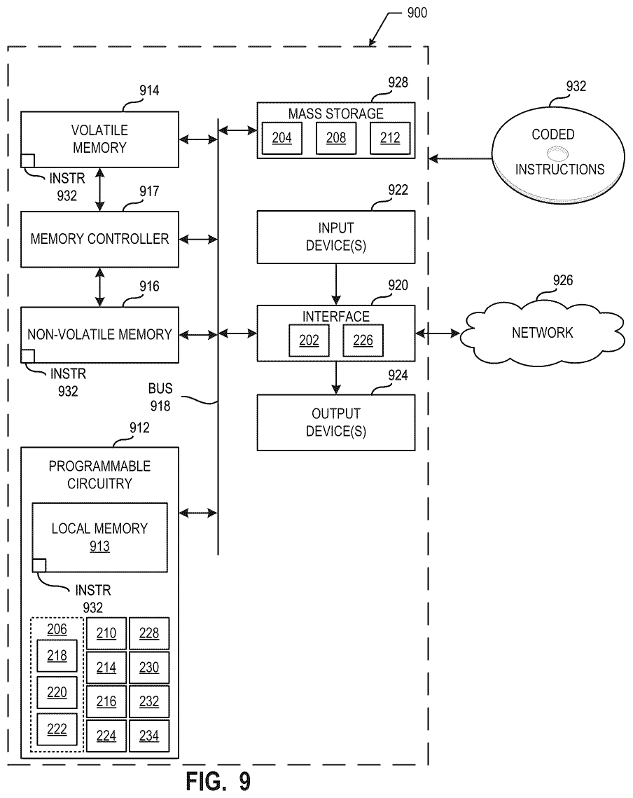

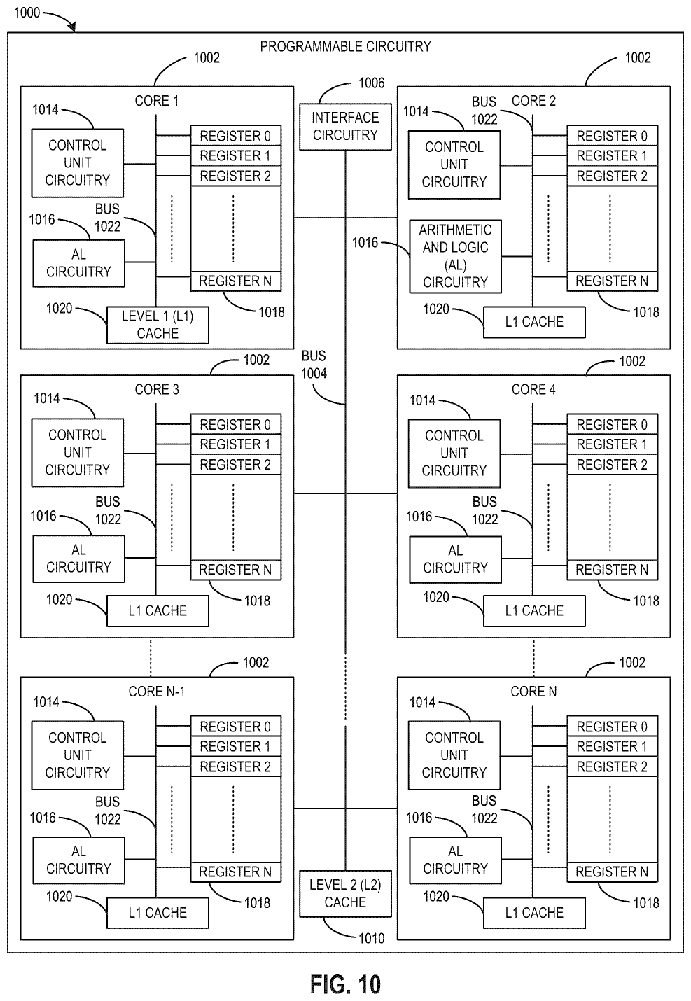

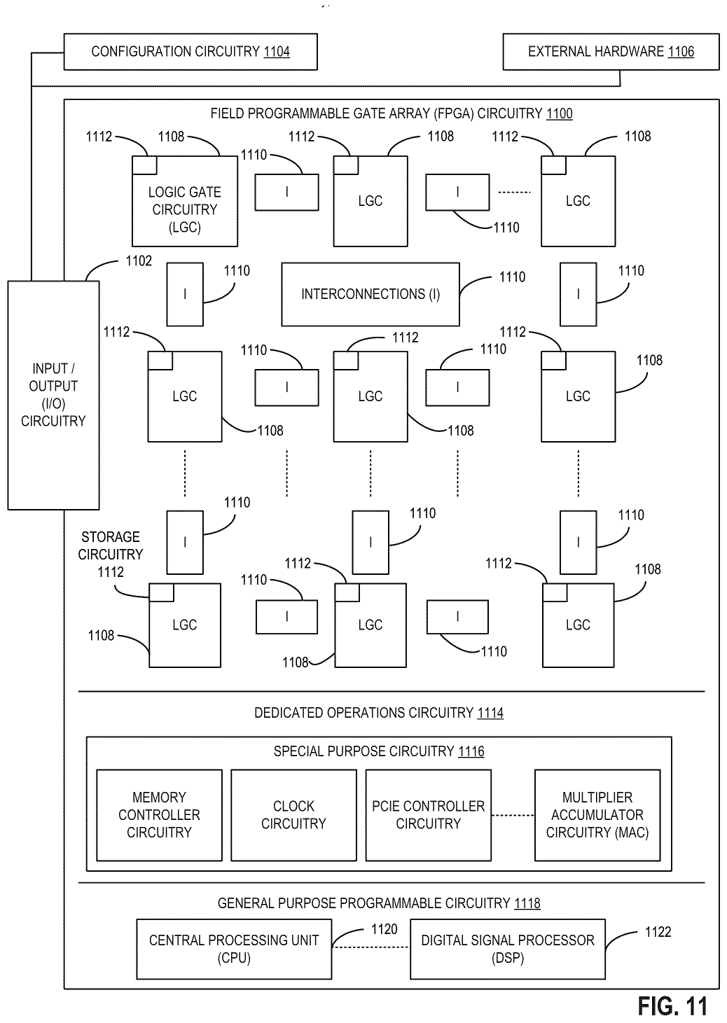

In some examples, the defect analysis system 106 includes means for monitoring objects. For example, the means for monitoring may be implemented by the object monitoring circuitry 206. In some examples, the object monitoring circuitry 206 may be instantiated by programmable circuitry such as the example programmable circuitry 912 of FIG. 9. For instance, the object monitoring circuitry 206 may be instantiated by the example microprocessor 1000 of FIG. 10 executing machine-executable instructions such as those implemented by at least blocks 602, 604, 606, and 614 of FIG. 6. In some examples, the object monitoring circuitry 206 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the object monitoring circuitry 206 may be instantiated by any other combination of hardware, software, and/or firmware. For example, the object monitoring circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 2, the object detection circuitry 218 detects one or more objects in a stream of sensor data and metadata. For example, the object detection circuitry 218 implements an object detection technique such as a computer vision technique. Example computer vision techniques include neural network-based approaches and non-neural network-based approaches. By detecting objects in a stream of sensor data and metadata, the object detection circuitry 218 facilitates the object monitoring circuitry 206 tracking objects over time.

Example neural network-based approaches include a convolutional neural network (CNN) based approach, a region proposal CNN-based approach (e.g., a region-based CNN (R-CNN) based approach, a fast R-CNN-based approach, a faster R-CNN-based approach, a cascade R-CNN-based approach, etc.), a Single Shot MultiBox Detector (SSD) based approach, a single-shot refinement neural network for object detection (RefineDet) based approach, a Retina-Net-based approach, and a deformable convolutional network-based approach. Example non-neural network-based approaches include a support vector machine (SVM) based approach, a Viola-Jones object detection framework based on Haar features, a scale-invariant feature transform (SIFT) based approach, and a histogram of oriented gradients (HOG) features-based approach. In some examples, the object detection circuitry 218 is instantiated by programmable circuitry executing object detection instructions and/or configured to perform operations such as those represented by the flowchart of FIG. 6.

In some examples, the defect analysis system 106 includes means for detecting an object. For example, the means for detecting may be implemented by the object detection circuitry 218. In some examples, the object detection circuitry 218 may be instantiated by programmable circuitry such as the example programmable circuitry 912 of FIG. 9. For instance, the object detection circuitry 218 may be instantiated by the example microprocessor 1000 of FIG. 10 executing machine-executable instructions such as those implemented by at least block 602 of FIG. 6. In some examples, the object detection circuitry 218 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the object detection circuitry 218 may be instantiated by any other combination of hardware, software, and/or firmware. For example, the object detection circuitry 218 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 2, the object identification circuitry 220 identifies one or more objects detected in a stream of sensor data and metadata. For example, the object identification circuitry 220 implements an object identification technique. For example, objects in the edge network environment 100 may be labeled with respective barcodes. Accordingly, the object identification circuitry 220 accesses the object identification database 208 to determine an identifying characteristic (e.g., a barcode) of an object.

In the illustrated example of FIG. 2, the object identification circuitry 220 compares features extracted from an input stream of sensor data and metadata to identifying characteristics. As such, the object identification circuitry 220 can identify a detected object as a specific object (e.g., a numbered package). In some examples, the object identification circuitry 220 utilizes computer vision techniques to identify objects based on other characteristics (e.g., size, shape, identifying marks, etc.) of an object. By identifying objects detected in a stream of sensor data and metadata, the object identification circuitry 220 facilitates the object monitoring circuitry 206 tracking objects over time. In some examples, the object identification circuitry 220 is instantiated by programmable circuitry executing object identification instructions and/or configured to perform operations such as those represented by the flowchart of FIG. 6.

In some examples, the defect analysis system 106 includes means for identifying an object. For example, the means for identifying may be implemented by the object identification circuitry 220. In some examples, the object identification circuitry 220 may be instantiated by programmable circuitry such as the example programmable circuitry 912 of FIG. 9. For instance, the object identification circuitry 220 may be instantiated by the example microprocessor 1000 of FIG. 10 executing machine-executable instructions such as those implemented by at least block 604 of FIG. 6. In some examples, the object identification circuitry 220 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the object identification circuitry 220 may be instantiated by any other combination of hardware, software, and/or firmware. For example, the object identification circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 2, the object tracking circuitry 222 tracks one or more objects that have been detected and identified in a stream of sensor data and metadata. For example, the object tracking circuitry 222 implements an object tracking algorithm to analyze sequential video frames and output the movements of targets between frames. Example object tracking techniques include kernel-based tracking-based approaches, contour tracking-based approaches, Kalman filter-based approaches, and particle filter-based approaches. By tracking objects that have been detected and identified in a stream of sensor data and metadata, the object identification circuitry 220 facilitates the object monitoring circuitry 206 tracking objects over time. In some examples, the object tracking circuitry 222 is instantiated by programmable circuitry executing object tracking instructions and/or configured to perform operations such as those represented by the flowchart of FIG. 6.

In some examples, the defect analysis system 106 includes means for tracking an object. For example, the means for tracking may be implemented by the object tracking circuitry 222. In some examples, the object tracking circuitry 222 may be instantiated by programmable circuitry such as the example programmable circuitry 912 of FIG. 9. For instance, the object tracking circuitry 222 may be instantiated by the example microprocessor 1000 of FIG. 10 executing machine-executable instructions such as those implemented by at least block 606 of FIG. 6. In some examples, the object tracking circuitry 222 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the object tracking circuitry 222 may be instantiated by any other combination of hardware, software, and/or firmware. For example, the object tracking circuitry 222 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

As described above, the object monitoring circuitry 206 includes the object detection circuitry 218, the object identification circuitry 220, and the object tracking circuitry 222 to detect, identify, and track objects over time in each stream of sensor data and metadata. As such, the object monitoring circuitry 206 outputs a stream of object identification metadata (e.g., video streams, frames, and location from where each object was detected, and the associated object identifier (ID)) associated with each input stream. For example, on a per input sensor data stream basis, the object monitoring circuitry 206 outputs a data structure of identified objects and/or non-identified objects that includes associated metadata describing the identified objects and/or non-identified objects. The stream of metadata output by the object monitoring circuitry 206 is useful in clustering events, finding events that are similar to an event in the metadata, and/or identifying the presence of similarities between events.

In the illustrated example of FIG. 2, the object identification database 208 is in communication with the object monitoring circuitry 206. In the example of FIG. 2, the object identification database 208 records data (e.g., identifying characteristics of objects, barcodes, sizes of objects, shapes of objects, identifying marks of objects, etc.). In the example of FIG. 2, the object identification database 208 may be implemented by a volatile memory (e.g., a SDRAM, DRAM, RDRAM, etc.) and/or a non-volatile memory (e.g., flash memory). The object identification database 208 may additionally or alternatively be implemented by one or more DDR memories, such as DDR, DDR2, DDR3, DDR4, DDR5, mDDR, DDR SDRAM, etc.

In the illustrated example of FIG. 2, the object identification database 208 may additionally or alternatively be implemented by one or more mass storage devices such as HDD(s), CD drive(s), DVD drive(s), SSD drive(s), SD card(s), CF card(s), etc. While in the illustrated example the object identification database 208 is illustrated as a single database, the object identification database 208 may be implemented by any number and/or type(s) of databases. Furthermore, the data stored in the object identification database 208 may be in any data format such as, for example, binary data, comma delimited data, tab delimited data, SQL structures, etc.

In the illustrated example of FIG. 2, the object correlation circuitry 210 is in communication with the historian database 204, the object monitoring circuitry 206, the sensor correlation parameter database 212, and the defect-to-object fusion circuitry 216. In the example of FIG. 2, the object correlation circuitry 210 correlates object metadata streams across input sensor data streams. In the example of FIG. 2, the object correlation circuitry 210 accesses the sensor correlation parameter database 212 to determine relationships between sensors represented in the streams of metadata from the object monitoring circuitry 206. For example, two or more cameras may view the same physical space from different angles. As such, the two or more cameras may collect data on the same object. Example relationships between sensors may be defined on the basis of sensor location (e.g., geographical coordinates of sensors, room location of sensors, etc.).

In the illustrated example of FIG. 2, based on relationships between two sensors, the object correlation circuitry 210 can apply statistical correlation techniques to correlate two or more streams of metadata corresponding to two or more sensors that collected data on the same object. For example, the object correlation circuitry 210 implements a technique based on Pearson's correlation coefficient, Spearman's rank correlation, among others. After correlating two or more stream of metadata, the object correlation circuitry 210 outputs a single object stream with timestamps (or frame identifiers) and metadata from the input streams.

For example, the object correlation circuitry 210 generates a timeline of an object that is representative of a path along which the object traveled through an environment. For example, a timeline of an object includes metadata associated with the object. Example metadata included with a timeline of an object is separated into one or more events where each event includes a timestamp (e.g., a time of the event) and at least one of a descriptor of the event, a location of a sensor at the time of the event, a descriptor of the object (e.g., object ID, object type, object contents, etc.), a descriptor of the environment that the object was exposed to at the time of the event, equipment that interacted with the object at the time of the event, an agent (e.g., an employee, staff, personnel, etc.) that interacted with the object at the time of the event, or other object(s) that interacted with at least one of the equipment or the agent at the time of the event. For example, the location of the sensor is indicative of a location of a sensor that reported data that has been synthesized into the timeline.

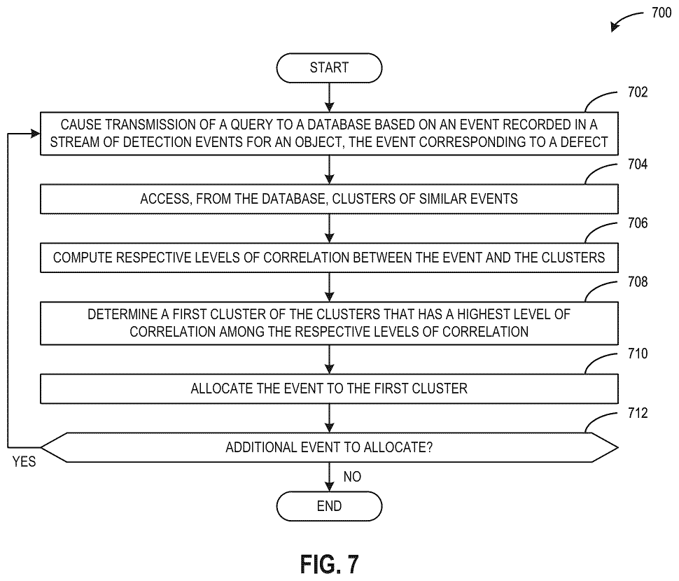

As such, a timeline generated by the object correlation circuitry 210 identifies a path and/or history of an object that indicates where the object travelled from, what route the object travelled along, which equipment was used to handle the object, the environment and/or climate the object was exposed to, agents and/or equipment that interacted with the object, time of delivery of the object, time of dispatch of the object, among others. Example equipment includes a forklift, a conveyor belt, a scissor lift, an AGV, a robot (e.g., a hydraulic and/or an electromechanical robot), a drone, etc. In the example of FIG. 2, the object correlation circuitry 210 causes storage of timelines of objects (e.g., identified and/or non-identified objects correlated across input sensor streams) in the historian database 204. In some examples, the object correlation circuitry 210 causes storage of a timeline of an object in the historian database 204 as a cluster of data. For example, the object correlation circuitry 210 creates a cluster representative of a timeline of an object so that the defect-to-object fusion circuitry 216 can attach any detected defects in the object to the cluster. In some examples, the object correlation circuitry 210 is instantiated by programmable circuitry executing object correlation instructions and/or configured to perform operations such as those represented by the flowcharts of FIGS. 6 and 7.

In some examples, the defect analysis system 106 includes means for correlating metadata. For example, the means for correlating may be implemented by the object correlation circuitry 210. In some examples, the object correlation circuitry 210 may be instantiated by programmable circuitry such as the example programmable circuitry 912 of FIG. 9. For instance, the object correlation circuitry 210 may be instantiated by the example microprocessor 1000 of FIG. 10 executing machine-executable instructions such as those implemented by at least block 608 of FIG. 6. In some examples, the object correlation circuitry 210 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the object correlation circuitry 210 may be instantiated by any other combination of hardware, software, and/or firmware. For example, the object correlation circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 2, the sensor correlation parameter database 212 is in communication with the object correlation circuitry 210 and the sensor correlation circuitry 234. In the example of FIG. 2, the sensor correlation parameter database 212 records data (e.g., sensor coordinates, known relationships between sensors, ascertained relationships between sensors, etc.). In the example of FIG. 2, the sensor correlation parameter database 212 may be implemented by a volatile memory (e.g., a SDRAM, DRAM, RDRAM, etc.) and/or a non-volatile memory (e.g., flash memory). The sensor correlation parameter database 212 may additionally or alternatively be implemented by one or more DDR memories, such as DDR, DDR2, DDR3, DDR4, DDR5, mDDR, DDR SDRAM, etc.

In the illustrated example of FIG. 2, the sensor correlation parameter database 212 may additionally or alternatively be implemented by one or more mass storage devices such as HDD(s), CD drive(s), DVD drive(s), SSD drive(s), SD card(s), CF card(s), etc. While in the illustrated example the sensor correlation parameter database 212 is illustrated as a single database, the sensor correlation parameter database 212 may be implemented by any number and/or type(s) of databases. Furthermore, the data stored in the sensor correlation parameter database 212 may be in any data format such as, for example, binary data, comma delimited data, tab delimited data, SQL structures, etc.

In the illustrated example of FIG. 2, the defect detection circuitry 214 is in communication with the receiver circuitry 202 and the defect-to-object fusion circuitry 216. In the example of FIG. 2, the defect detection circuitry 214 generates metadata including identifying characteristics (e.g., shape, color, package type, size (e.g., big, small, etc.), barcode, etc.) of objects in each stream of sensor data that includes defects. For example, in a shipping example, the defect detection circuitry 214 detects boxes that are open and/or damaged. In the example of FIG. 2, the defect detection circuitry 214 generates metadata for defects detected in each frame of each input sensor data stream.

In the illustrated example of FIG. 2, the defect detection circuitry 214 utilizes a flow-based architecture such as CFLOW-AD, FastFlow, etc. In some examples, the defect detection circuitry 214 utilizes a deep learning-based architecture such as a Patch Distribution Modeling (PaDiM) framework, a Student-Teacher Feature Pyramid Matching (STFPM) framework, a PatchCore framework, etc. In additional or alternative examples, the defect detection circuitry 214 utilizes any other defect detection technique. In some examples, the defect detection circuitry 214 is instantiated by programmable circuitry executing defect detection instructions and/or configured to perform operations such as those represented by the flowchart of FIG. 6.

In some examples, the defect analysis system 106 includes means for detecting a defect. For example, the means for detecting may be implemented by the defect detection circuitry 214. In some examples, the defect detection circuitry 214 may be instantiated by programmable circuitry such as the example programmable circuitry 912 of FIG. 9. For instance, the defect detection circuitry 214 may be instantiated by the example microprocessor 1000 of FIG. 10 executing machine-executable instructions such as those implemented by at least block 610 of FIG. 6. In some examples, the defect detection circuitry 214 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the defect detection circuitry 214 may be instantiated by any other combination of hardware, software, and/or firmware. For example, the defect detection circuitry 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 2, the defect-to-object fusion circuitry 216 is in communication with the historian database 204, the object correlation circuitry 210, and the defect detection circuitry 214. In some examples, the defect-to-object fusion circuitry 216 is referred to as defect-to-object correlation circuitry. Additionally or alternatively, the defect-to-object fusion circuitry 216 is referred to as defect correlation circuitry. In the example of FIG. 2, the defect-to-object fusion circuitry 216 matches (e.g., assigns, correlates, etc.) detected defects with specific objects being tracked. For example, the defect-to-object fusion circuitry 216 correlates a frame of an input stream in which a defect to an object was detected with a timeline of the object based on the frame being identified in the metadata of the timeline. As such, the defect-to-object fusion circuitry 216 supplements a timeline of an object with one or more detected defects to generate a defect-aware timeline of the object.

In the example of FIG. 2, the defect-to-object fusion circuitry 216 causes storage of defect-aware timelines in the historian database 204 for visualization and/or further analysis. For example, the defect-to-object fusion circuitry 216 causes storage of metadata for defects detected for each identified and/or non-identified object. In some examples, when a new defect is detected, the defect-to-object fusion circuitry 216 adds the defect to one or more of the clusters of data in the historian database 204.

For example, the historian database 204 includes a first cluster of defects related to water and/or moisture damage and a second cluster of defects related to broken contents of and/or dampened packages. As the defect detection circuitry 214 detects a defect in a frame of sensor data, the defect-to-object fusion circuitry 216 queries the historian database 204 to fetch one or more clusters of similar defects and allocates the defect to a specific cluster. For example, given an event (e.g., in a timeline of an object) that corresponds to a defect in an object, the defect-to-object fusion circuitry 216 accesses clusters (e.g., is to access clusters) of similar events from the historian database 204. Similar events to an event corresponding to a defect in an object include events that occurred at the time the defect was reported, events that share a defect type with the defect, events that share equipment that interacted with the object at the time the defect was reported, and events that share an agent that interacted with the object at the time the defect was reported. In the example of FIG. 2, the defect-to-object fusion circuitry 216 identifies one of the clusters to which the event is to be assigned.

For example, the defect-to-object fusion circuitry 216 identifies the cluster to which the event is to be assigned based on correlation details computed for the event and the clusters of similar events. Example correlation details include an identifier of an object associated with an event to be clustered, a candidate cluster to which the event may be clustered, a confidence score for a level of correlation between the event and a similar event in the candidate cluster, an identifier of an object associated with the similar event, and the level of correlation between the event and the similar event in the candidate cluster. In the example of FIG. 2, based on the correlation details (e.g., the level of correlation and/or the confidence score) for each cluster of similar events, the defect-to-object fusion circuitry 216 allocates the event to one of the clusters of similar events. In some examples, the defect-to-object fusion circuitry 216 is instantiated by programmable circuitry executing defect-to-object fusion instructions and/or configured to perform operations such as those represented by the flowchart of FIG. 6.

In some examples, the defect analysis system 106 includes means for correlating defects with objects. For example, the means for correlating may be implemented by the defect-to-object fusion circuitry 216. In some examples, the defect-to-object fusion circuitry 216 may be instantiated by programmable circuitry such as the example programmable circuitry 912 of FIG. 9. For instance, the defect-to-object fusion circuitry 216 may be instantiated by the example microprocessor 1000 of FIG. 10 executing machine-executable instructions such as those implemented by at least block 612 of FIG. 6 and/or at least blocks 702, 704, 706, 708, 710, and 712 of FIG. 7. In some examples, the defect-to-object fusion circuitry 216 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the defect-to-object fusion circuitry 216 may be instantiated by any other combination of hardware, software, and/or firmware. For example, the defect-to-object fusion circuitry 216 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

As described above, both the object correlation circuitry 210 and the defect-to-object fusion circuitry 216 correlate object detection events and defect detections to specific objects and update the historian database 204. As such, when an object detection event is processed, the object correlation circuitry 210 queries the historian database 204 based on metadata for (e.g., a timeline of, location of, equipment that interacted with, etc.) the object to identify a correlation between the object and a cluster of similar objects. As such, the object correlation circuitry 210 tags the object as similar to and/or dissimilar to other objects clustered in the historian database 204.

Additionally or alternatively, when a defect detection is processed, the defect-to-object fusion circuitry 216 queries the historian database 204 based on the defect and/or metadata for the object to identify a correlation between the defect and a cluster of similar defects. As such, the defect-to-object fusion circuitry 216 tags the defect as similar to and/or dissimilar to other defects clustered in the historian database 204. Accordingly, the object correlation circuitry 210 and the defect-to-object fusion circuitry 216 assist in tracking an object over the lifetime of the object in an environment and assist the cause analysis circuitry 230 in identifying a candidate cause of certain category (e.g., type) of defect.

In the illustrated example of FIG. 2, the visualizer circuitry 224 is in communication with the historian database 204, the transmitter circuitry 226, the cause analysis circuitry 230, and the cost analysis circuitry 232. In the example of FIG. 2, the visualizer circuitry 224 implements a backend of a warehouse management application. For example, the visualizer circuitry 224 hosts an application that allows an end-user to visualize the data included in the historian database 204 and/or to query the historian database 204.

For example, a user could focus on a given defect that was detected in a given object. The user could access the historian database 204 via the application hosted by the visualizer circuitry 224 to determine when a defect was first detected in an object and/or to view input streams of sensor data along the lifetime of detections of the object (e.g., the timeline of the object), regardless of whether the defect was visible in a given input stream and/or detection. For example, the visualizer circuitry 224 allows a user to determine whether an object was defective when received (e.g., at the shipping dock) or whether the object was damaged in subsequent handling. If an object (e.g., a product) was received in a defective state, a user could use the timeline of the object (e.g., stored in the historian database 204) to generate a claim for reimbursement.

In the illustrated example of FIG. 2, the transmitter circuitry 226 is in communication with the visualizer circuitry 224. Additionally, the transmitter circuitry 226 is in communication with one or more end-user devices (e.g., end-user devices of the edge network environment 100 of FIG. 1). In the example of FIG. 2, the transmitter circuitry 226 provides access to the application hosted by the visualizer circuitry 224 to one or more end-user devices (e.g., of the edge network environment 100 of FIG. 1).

In the illustrated example of FIG. 2, the clustering and correlation circuitry 228 is in communication with the historian database 204, the cause analysis circuitry 230, and the cost analysis circuitry 232. In the example of FIG. 2, the clustering and correlation circuitry 228 clusters data in the historian database 204 across time and space to identify commonalities across defects. For example, the clustering and correlation circuitry 228 can identify common environmental conditions that objects having similar defects were exposed to, where in a factory defects are most often get introduced, whether the defects are caused by a specific machine, whether the defects most often occur at a specific time of day and/or during a specific shift, whether a specific event in time caused many related defects, and/or whether the defects occur in the same place, at the same time, and/or when in contact with the same people and/or machines. In the example of FIG. 2, the clustering and correlation circuitry 228 implements a statistical technique to cluster data such as k-means clustering-based technique, a Gaussian mixture model-based technique, etc. Additionally or alternatively, the clustering and correlation circuitry 228 implements a deep learning-based technique to correlate data.

As such, the clustering and correlation circuitry 228 identifies whether there are any patterns in detected defects. For example, if objects with water damage are frequently placed in a certain area of a warehouse and/or facility at a certain time, the clustering and correlation circuitry 228 identifies that events occurring in the certain area and/or events occurring at and/or during the certain time may be causing the defect. Accordingly, the clustering and correlation circuitry 228 assists the cause analysis circuitry 230 in identifying a cause of a defect.

In the illustrated example of FIG. 2, the cause analysis circuitry 230 is in communication with the historian database 204, the visualizer circuitry 224, the clustering and correlation circuitry 228, and the cost analysis circuitry 232. In the example of FIG. 2, the cause analysis circuitry 230 determines a candidate cause (e.g., a root cause) of a defect to an object or a cluster of defects. For example, the cause analysis circuitry 230 implements a machine learning-based technique such as a clustering-based technique, a tree-based technique, an SVM-based technique, a CNN-based technique, etc. to determine a candidate cause of a defect or cluster of defects.

In the illustrated example of FIG. 2, to determine a cause of a defect, the cause analysis circuitry 230 queries the historian database 204 and/or the clustering and correlation circuitry 228 based on metadata of a defect to an object. For example, the metadata of the defect to the object corresponds to a defect type of the defect. Additionally or alternatively, the metadata of the defect to the object corresponds to metadata of an event in a timeline of the object at the time when the defect was recorded (e.g., by a sensor).

In the illustrated example of FIG. 2, the cause analysis circuitry 230 accesses data from the historian database 204 and/or the clustering and correlation circuitry 228 based on the query. For example, the cause analysis circuitry 230 accesses metadata that was generated by a sensor (e.g., in the environment where the defect was detected) within a threshold period of the time when the defect was recorded. Additionally or alternatively, the cause analysis circuitry 230 accesses metadata that was generated by a sensor in the environment where the defect was detected but before the defect was detected. In some examples, the cause analysis circuitry 230 accesses metadata that was generated by a sensor in a different environment than the environment where the defect was detected.

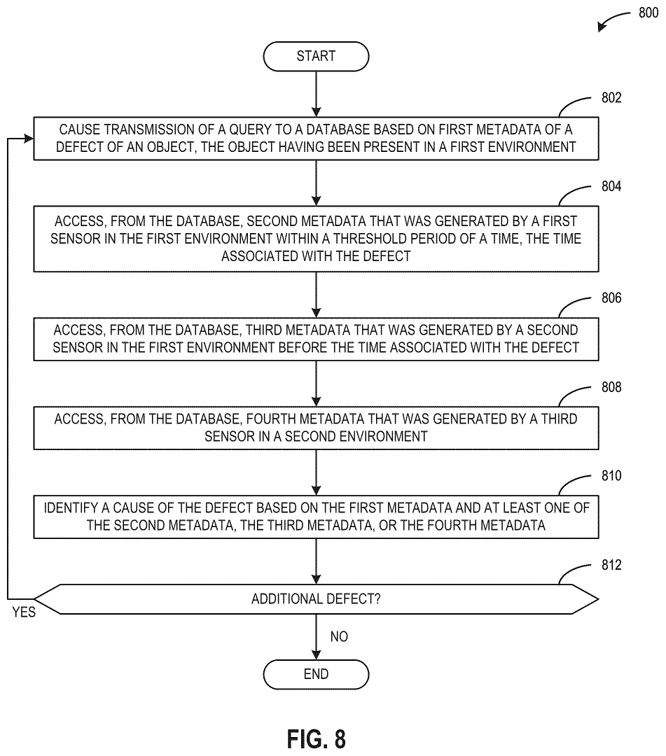

In the illustrated example of FIG. 2, based on the timeline of object and the data accessed from the historian database 204 and/or the clustering and correlation circuitry 228, the cause analysis circuitry 230 identifies a candidate cause of a defect to an object. Accordingly, the cause analysis circuitry 230 can cause transmission of an alert to an end-user to remediate the cause to prevent further defects. For example, if the clustering and correlation circuitry 228 generates a cluster indicating that several packages are exposed to high humidity in a particular area of a warehouse, the cause analysis circuitry 230 can transmit an alert to an end-user to instruct the end-user to avoid storing packages in the particular area of the warehouse. If the warehouse includes autonomous vehicles, the cause analysis circuitry 230 can instruct autonomous vehicles to avoid storing packages in the particular area of the warehouse. As such, damage to future packages can be avoided. In some examples, the cause analysis circuitry 230 is instantiated by programmable circuitry executing cause analysis instructions and/or configured to perform operations such as those represented by the flowchart of FIG. 8.

In some examples, the defect analysis system 106 includes means for identifying a cause. For example, the means for identifying may be implemented by the cause analysis circuitry 230. In some examples, the cause analysis circuitry 230 may be instantiated by programmable circuitry such as the example programmable circuitry 912 of FIG. 9. For instance, the cause analysis circuitry 230 may be instantiated by the example microprocessor 1000 of FIG. 10 executing machine-executable instructions such as those implemented by at least blocks 802, 804, 806, 808, 810, and 812 of FIG. 8. In some examples, the cause analysis circuitry 230 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the cause analysis circuitry 230 may be instantiated by any other combination of hardware, software, and/or firmware. For example, the cause analysis circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In the illustrated example of FIG. 2, the cost analysis circuitry 232 is in communication with the visualizer circuitry 224, the clustering and correlation circuitry 228, and the cause analysis circuitry 230. In the example of FIG. 2, the cost analysis circuitry 232 allows a user to determine what causes, equipment (e.g., machines), processes, and/or personnel are causing the highest total monetary loss (across multiple correlated incidents), allowing for a cost-reducing remediation to be developed. For example, the cost analysis circuitry 232 can analyze clusters of events experiencing similar defects and look at a variety of causes of the similar defects based on one or more candidate causes identified by the cause analysis circuitry 230. As such, the cost analysis circuitry 232 allows a user to focus on remediations that can save more money than other remediations, rather than remediations for the most frequently observed defects (e.g., some of which may have a significantly lower cost).

In some examples, the clustering and correlation circuitry 228, the cause analysis circuitry 230, and/or the cost analysis circuitry 232 operate on data from multiple environments (e.g., a first warehouse environment, a second warehouse environment, etc.). In such examples, the clustering and correlation circuitry 228 clusters data from multiple historian databases across environments. As such, the cause analysis circuitry 230 and/or the cost analysis circuitry 232 can query clusters of data across multiple environments for analysis. Thus, for example, the cause analysis circuitry 230 and/or a user could correlate common defect occurrences across multiple manufacturing plants that might utilize common equipment and/or common procedures.

In the illustrated example of FIG. 2, the sensor correlation circuitry 234 is in communication with the historian database 204 and the sensor correlation parameter database 212. In the example of FIG. 2, the sensor correlation circuitry 234 provides a feedback loop to update the sensor correlation parameter database 212. For example, the sensor correlation parameter database 212 can update sensor correlation parameters that are used by the object correlation circuitry 210 to correlation object detections and tracking across input streams of sensor data. For example, if two sensors frequently detect the same object at the same time, then the sensor correlation circuitry 234 determines that the two sensors are likely sensing the same physical space, perhaps using different modalities or from different perspectives. Similarly, if a first sensor frequently detects an object within a threshold period of time before a second sensor detects the object, then the sensor correlation circuitry 234 determines that the first sensor and the second sensor are likely physically near each other.

In some examples, if a first sensor frequently captures images of a first side of an object and a second sensor frequently captures images of a second side of the object opposite of the first side, then the sensor correlation circuitry 234 determines that the first sensor and the second sensor are positioned on opposite sides of the sample physical space. For example, based on the object correlation circuitry 210 determining that streams of data from two sensors include the same object detected in the same physical space, the sensor correlation circuitry 234 determines that the two sensors are situated on different sides of the same physical space. The sensor correlation circuitry 234 updates the sensor correlation parameter database 212 with sensor relationships to allow the object correlation circuitry 210 to better correlate object detections across multiple sensors in subsequent operation.

As described above, the defect analysis system 106 creates a timeline of events with metadata that illustrates the path travelled by and object and/or the environment to which the object was exposed including personnel and/or equipment that interacted with the object. For example, in a warehouse environment, pallet #271 may be received on Monday at 10:00 AM. In this example, pallet #271 contains glassware and was received from a manufacturer, Acme Manufacturing.

In the example, when pallet #271 was received, the same truck was carrying glassware (e.g., drinking glasses), glass food containers, and plush toys. The truck was unloaded by employee ID 359 using forklift 7 at gate #8. As pallet #271 was unloaded, two out 24 pallets on the same truck were declined because the two pallets were damaged. Later, at 2:17 PM on Monday, pallet #271 was moved to a staging area by an employee using forklift 9. At 6:12 PM on Monday, pallet #271 was sent to aisle 17 and bin 31 by an employee using forklift 6. Later on Monday, a camera in aisle 17 detected pallet #271 and an audio sensor picked up the sound of broken glass rattling. On Wednesday, an employee registered a customer complaint that two glasses out of a six pack of glasses from pallet #271 were broken.

In such an example, the defect-to-object fusion circuitry 216 generates a defect-aware timeline for pallet #271. For example, the defect-aware timeline for pallet #271 is illustrated in Table 1 below. In Table 1, timestamps are recorded in terms of 24-hour clock.

TABLE 1

| Timestamp | Metadata |
|---|---|
| Monday 10:00 | [arrival, warehouse 211, gate 8, glassware, |
| | item id: 1918, truck id, 24 pallets, . . . ] |
| Monday 10:19 | [employee 359, forklift 7, . . . ] |
| Monday 14:17 | [staging, forklift 9, . . . ] |
| Monday 18:12 | [forklift 9, aisle 17, . . . ] |
| Wednesday 11:42 | [broken glass, employee 789, . . . ] |

Based on the defect-aware timeline of pallet #271, the cause analysis circuitry 230 queries the historian database 204 and/or the clustering and correlation circuitry 228 to determine when the event of broken glass first occurred. For example, the cause analysis circuitry 230 queries the historian database 204 and/or the clustering and correlation circuitry 228 to sensor data, metadata, and/or aggregated data recorded within a threshold period of the time when the defect in pallet #271 was recorded (e.g., on the same day when the defect was recorded) to determine the first instance of a similar defect. Thus, in the above-described examples, the cause analysis circuitry 230 generates a query that requests audio data (including data from cameras including microphones) from sensors that were positioned along the path that pallet #271 travelled to determine if data corresponding to broken glass was collected (but perhaps not detected as a defect) before the Wednesday entry in Table 1.

Additionally, the cause analysis circuitry 230 can query the historian database 204 and/or the clustering and correlation circuitry 228 to determine whether any sensors that were positioned along the path that pallet #271 travelled detected an impact (e.g., perhaps an employee dropping pallet #271), which would suggest a root cause to the broken glass. As described above, the cause analysis circuitry 230 can query the historian database 204 as a centralized database and/or as a distributed database including caches located at and/or near sensors. In some examples, the cause analysis circuitry 230 determines if a similar sequence of events has occurred in the past.

For example, the cause analysis circuitry 230 determines whether the warehouse has received similar complaints of broken items after forklift 6, 7, or 9 handled objects in the warehouse. Additionally, the cause analysis circuitry 230 can query how often similar events occur when forklifts 6, 7, or 9 handle objects in the warehouse. If similar defects occur frequently when forklift 6, 7, or 9 handle object in the warehouse, the cause analysis circuitry 230 determines that there is an issue with at least one of forklift 6, 7, or 9 and can schedule maintenance for forklift 6, 7, and 9 Similarly, the cause analysis circuitry 230 can perform cross-site analysis to determine, based on data from historian databases in multiple sites, whether impact-based breakage is a common occurrence across plants. If the cause analysis circuitry 230 determines that impact-based breakage is a common occurrence across plants, then the cause analysis circuitry 230 determines that procedures should be updated across sites and triggers an alert to managers of each site. As such, examples disclosed herein include crowdsourcing for possible recurring events.

In some examples, the defect-to-object fusion circuitry 216 allocates events to clusters of events in the historian database 204. For example, if an additional sensor reported broken glass in an event on Monday at 6:10 PM for pallet #271, the event entry may be represented as follows: Timestamp=Monday 18:10, metadata=[forklift 9, aisle 16, . . . ]. In the example of pallet #271, the defect-to-object fusion circuitry 216 queries the historian database 204 to fetch information about similar incidents. For example, the historian database 204 returns information from prior reported incidents that share various details such as aggregated data for timestamp, defect type, equipment used, employees involved, etc.

Based on the data returned from the historian database 204, the defect-to-object fusion circuitry 216 computes the cluster to which the new incident should be allocated, confidence score, correlated item, and/or correlation level. For example, the defect-to-object fusion circuitry 216 determines that the 6:10 PM event should be allocated to cluster six (e.g., the same cluster as the previous broken glass event for pallet #271) based on the following correlation details: [item id: 1919, cluster: 6, confidence score: 95%, correlated item: 1918, correlation level: High]. The example event reported by the additional sensor is similar to the previous broken glass event for pallet #271.

As such, the defect-to-object fusion circuitry 216 allocates the event data reported from the additional sensor to the same cluster as the previous broken glass event for pallet #271. As the correlation level is high, it is likely that the additional sensor is reporting the same incident. For example, because the same forklift (e.g., forklift 9) was used at almost the same time when another sensor reported that pallet #271 was being handled by forklift 9, the defect-to-object fusion circuitry 216 determines that the two events are correlated (e.g., there is a high possibility that forklift 9 was moving pallet #271 from aisle 15 or aisle 16 to aisle 17). The defect-to-object fusion circuitry 216 updates the historian database 204 based on such determinations.

In the example of FIG. 2, the defect-to-object fusion circuitry 216 can continuously update clusters in the historian database 204 as and when a new defect events are reported. As such, any new type of damage and associated metadata is organized in the historian database 204. In some examples, data in the historian database 204 may be clustered at a higher level (e.g., based on defect type) by the clustering and correlation circuitry 228. As such, each higher-level cluster may include one or more sub-clusters.

In another example, in the same warehouse environment as the example of pallet #271, after few days, another incident of broken glasses is reported. As the defect type is recurring, the cause analysis circuitry 230 determines a candidate cause for the defect. Example metadata for the subsequent incident may be represented as illustrated in Table 2 below. In Table 2, timestamps are recorded in terms of 24-hour clock.

TABLE 2

| Timestamp | Metadata |
|---|---|
| Thursday 10:00 | [arrival, warehouse 211, gate 9, |
| | glassware, item id: 2081, truck |
| | id, 19 pallets, . . . ] |
| Thursday 10:15 | [employee 569, forklift 7, . . . ] |
| Thursday 14:27 | [staging, forklift 9, . . . ] |
| Thursday 18:22 | [forklift 9, aisle 26, . . . ] |
| Saturday 11:47 | [broken glass, employee 395, . . . ] |

To correlate the broken glass event of this example, the defect-to-object fusion circuitry 216 queries the historian database 204 to fetch aggregated data for prior similar incident. Then, the defect-to-object fusion circuitry 216 computes correlation details for the broken glass event of this example and updates the historian database 204. For example, the defect-to-object fusion circuitry 216 correlates events based on all available metadata for the events. As the broken glass event of this example is similar to the broken glass event of the example of pallet #271, the defect-to-object fusion circuitry 216 allocates the broken glass event of this example to the same cluster (e.g., cluster six) as the broken glass event of the example of pallet #271 with confidence score as 92%, correlated item 1918, correlation level as mid. For example, the correlation details are as follows: [item id: 2081, cluster: 6, confidence score: 95%, correlated item: 1918, correlation level: Mid].

In the above-described example, the cause analysis circuitry 230 queries the historian database 204 for similar events in the same cluster (e.g., cluster six) to identify commonalities and further inspect for candidate causes. In this example, the cause analysis circuitry 230 identifies two common factors with the example of pallet #271, forklift 9 and the time of the day (e.g., between 14:00 to 14:30). The cause analysis circuitry 230 updates the historian database 204 with these details for subsequent analysis. Based on the common factors, the cause analysis circuitry 230 identifies candidate causes including that forklift 9 is problematic or some incident repeatedly happens during the specific time of the day, which would require further analysis. In some examples, the visualizer circuitry 224 displays the candidate causes and/or common factors to a user (e.g., a warehouse manager) who may further audit forklift 9 and/or activities during the identified period of time.

In some examples, in the above-described examples, the cost analysis circuitry 232 determines that while impact-based breakages are common, water damage to pallets left outside during poor weather results in a more significant monetary loss than impact damage. Additionally or alternatively, the cause analysis circuitry 230 determines that water damage to pallets also occurs in packages kept inside the warehouse and identifies a potential cause as leakage in the warehouse exterior (e.g., roof, walls, etc.). In such examples, the cost analysis circuitry 232 produces a candidate cost for repairing the warehouse exterior. Thus, a plant manager can use the cost analysis to decide how to remediate the cause of defects. For example, if the cost of repairing the warehouse exterior is overly expensive, the plant manager might decide to change procedures during weather events (e.g., store inventory in different locations) to avoid water damage.

While an example manner of implementing the defect analysis system 106 of FIG. 1 is illustrated in FIG. 2, one or more of the elements, processes, and/or devices illustrated in FIG. 2 may be combined, divided, re-arranged, omitted, eliminated, and/or implemented in any other way. Further, the example receiver circuitry 202, the example historian database 204, the example object monitoring circuitry 206, the example object identification database 208, the example object correlation circuitry 210, the example sensor correlation parameter database 212, the example defect detection circuitry 214, the example defect-to-object fusion circuitry 216, the example object detection circuitry 218, the example object identification circuitry 220, the example object tracking circuitry 222, the example visualizer circuitry 224, the example transmitter circuitry 226, the example clustering and correlation circuitry 228, the example cause analysis circuitry 230, the example cost analysis circuitry 232, the example sensor correlation circuitry 234, and/or, more generally, the example defect analysis system 106 of FIG. 2, may be implemented by hardware alone or by hardware in combination with software and/or firmware. Thus, for example, any of the example receiver circuitry 202, the example historian database 204, the example object monitoring circuitry 206, the example object identification database 208, the example object correlation circuitry 210, the example sensor correlation parameter database 212, the example defect detection circuitry 214, the example defect-to-object fusion circuitry 216, the example object detection circuitry 218, the example object identification circuitry 220, the example object tracking circuitry 222, the example visualizer circuitry 224, the example transmitter circuitry 226, the example clustering and correlation circuitry 228, the example cause analysis circuitry 230, the example cost analysis circuitry 232, the example sensor correlation circuitry 234, and/or, more generally, the example defect analysis system 106 of FIG. 2, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example defect analysis system 106 of FIG. 2 may include one or more elements, processes, and/or devices in addition to, or instead of, those illustrated in FIG. 2, and/or may include more than one of any or all of the illustrated elements, processes, and devices.

FIG. 3 is a block diagram 300 showing an overview of a configuration for Edge computing, which includes a layer of processing referred to in many of the following examples as an “Edge cloud”. As shown, the Edge cloud 310 is co-located at an Edge location, such as an access point or base station 340, a local processing hub 350, or a central office 320, and thus may include multiple entities, devices, and equipment instances. The Edge cloud 310 is located much closer to the endpoint (consumer and producer) data sources 360 (e.g., autonomous vehicles 361, user equipment 362, business and industrial equipment 363, video capture devices 364, drones 365, smart cities and building devices 366, sensors and IoT devices 367, etc.) than the cloud data center 330. Compute, memory, and storage resources which are offered at the edges in the Edge cloud 310 are critical to providing ultra-low latency response times for services and functions used by the endpoint data sources 360 as well as reduce network backhaul traffic from the Edge cloud 310 toward cloud data center 330 thus improving energy consumption and overall network usages among other benefits.

Compute, memory, and storage are scarce resources, and generally decrease depending on the Edge location (e.g., fewer processing resources being available at consumer endpoint devices, than at a base station, than at a central office). However, the closer that the Edge location is to the endpoint (e.g., user equipment (UE)), the more that space and power is often constrained. Thus, Edge computing attempts to reduce the amount of resources needed for network services, through the distribution of more resources which are located closer both geographically and in network access time. In this manner, Edge computing attempts to bring the compute resources to the workload data where appropriate or bring the workload data to the compute resources.

The following describes aspects of an Edge cloud architecture that covers multiple potential deployments and addresses restrictions that some network operators or service providers may have in their own infrastructures. These include, variation of configurations based on the Edge location (because edges at a base station level, for instance, may have more constrained performance and capabilities in a multi-tenant scenario); configurations based on the type of compute, memory, storage, fabric, acceleration, or like resources available to Edge locations, tiers of locations, or groups of locations; the service, security, and management and orchestration capabilities; and related objectives to achieve usability and performance of end services. These deployments may accomplish processing in network layers that may be considered as “near Edge,” “close Edge,” “local Edge,” “middle Edge,” or “far Edge” layers, depending on latency, distance, and timing characteristics.

Edge computing is a developing paradigm where computing is performed at or closer to the “Edge” of a network, typically through the use of a compute platform (e.g., x86 or ARM compute hardware architecture) implemented at base stations, gateways, network routers, or other devices which are much closer to endpoint devices producing and consuming the data. For example, Edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within Edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

FIG. 4 illustrates operational layers among endpoints, an Edge cloud, and cloud computing environments. Specifically, FIG. 4 depicts examples of computational use cases 405, utilizing the Edge cloud 310 among multiple illustrative layers of network computing. The layers begin at an endpoint (devices and things) layer 400, which accesses the Edge cloud 310 to conduct data creation, analysis, and data consumption activities. The Edge cloud 310 may span multiple network layers, such as an Edge devices layer 410 having gateways, on-premise servers, or network equipment (nodes 415) located in physically proximate Edge systems; a network access layer 420, encompassing base stations, radio processing units, network hubs, regional data centers (DC), or local network equipment (equipment 425); and any equipment, devices, or nodes located therebetween (in layer 412, not illustrated in detail). The network communications within the Edge cloud 310 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 400, under 5 ms at the Edge devices layer 410, to even between 10 to 40 ms when communicating with nodes at the network access layer 420. Beyond the Edge cloud 310 are core network 430 and cloud data center 440 layers, each with increasing latency (e.g., between 50-60 ms at the core network layer 430, to 100 or more ms at the cloud data center layer). As a result, operations at a core network data center 435 or a cloud data center 445, with latencies of at least 50 to 100 ms or more, will not be able to accomplish many time-critical functions of the use cases 405. Each of these latency values are provided for purposes of illustration and contrast; it will be understood that the use of other access network mediums and technologies may further reduce the latencies. In some examples, respective portions of the network may be categorized as “close Edge,” “local Edge,” “near Edge,” “middle Edge,” or “far Edge” layers, relative to a network source and destination. For instance, from the perspective of the core network data center 435 or a cloud data center 445, a central office or content data network may be considered as being located within a “near Edge” layer (“near” to the cloud, having high latency values when communicating with the devices and endpoints of the use cases 405), whereas an access point, base station, on-premise server, or network gateway may be considered as located within a “far Edge” layer (“far” from the cloud, having low latency values when communicating with the devices and endpoints of the use cases 405). It will be understood that other categorizations of a particular network layer as constituting a “close,” “local,” “near,” “middle,” or “far” Edge may be based on latency, distance, number of network hops, or other measurable characteristics, as measured from a source in any of the network layers 400-440.

The various use cases 405 may access resources under usage pressure from incoming streams, due to multiple services utilizing the Edge cloud. To achieve results with low latency, the services executed within the Edge cloud 310 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor, etc.).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to Service Level Agreement (SLA), the system as a whole (components in the transaction) may provide the ability to (1) understand the impact of the SLA violation, and (2) augment other components in the system to resume overall transaction SLA, and (3) implement actions to remediate.

Thus, with these variations and service features in mind, Edge computing within the Edge cloud 310 may provide the ability to serve and respond to multiple applications of the use cases 405 (e.g., object tracking, video surveillance, connected cars, etc.) in real-time or near real-time, and meet ultra-low latency requirements for these multiple applications. These advantages enable a whole new class of applications (e.g., Virtual Network Functions (VNFs), Function as a Service (FaaS), Edge as a Service (EaaS), standard processes, etc.), which cannot leverage conventional cloud computing due to latency or other limitations.

However, with the advantages of Edge computing comes the following caveats. The devices located at the Edge are often resource constrained and therefore there is pressure on usage of Edge resources. Typically, this is addressed through the pooling of memory and storage resources for use by multiple users (tenants) and devices. The Edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required because Edge locations may be unmanned and may even need permissioned access (e.g., when housed in a third-party location). Such issues are magnified in the Edge cloud 310 in a multi-tenant, multi-owner, or multi-access setting, where services and applications are requested by many users, especially as network usage dynamically fluctuates and the composition of the multiple stakeholders, use cases, and services changes.

At a more generic level, an Edge computing system may be described to encompass any number of deployments at the previously discussed layers operating in the Edge cloud 310 (network layers 400-440), which provide coordination from client and distributed computing devices. One or more Edge gateway nodes, one or more Edge aggregation nodes, and one or more core data centers may be distributed across layers of the network to provide an implementation of the Edge computing system by or on behalf of a telecommunication service provider (“telco,” or “TSP”), internet-of-things service provider, cloud service provider (CSP), enterprise entity, or any other number of entities. Various implementations and configurations of the Edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the Edge computing system does not necessarily mean that such node or device operates in a client or agent/minion/follower role; rather, any of the nodes or devices in the Edge computing system refer to individual entities, nodes, or subsystems which include discrete or connected hardware or software configurations to facilitate or use the Edge cloud 310.

As such, the Edge cloud 310 is formed from network components and functional features operated by and within Edge gateway nodes, Edge aggregation nodes, or other Edge compute nodes among network layers 410-430. The Edge cloud 310 thus may be embodied as any type of network that provides Edge computing and/or storage resources which are proximately located to radio access network (RAN) capable endpoint devices (e.g., mobile computing devices, IoT devices, smart devices, etc.), which are discussed herein. In other words, the Edge cloud 310 may be envisioned as an “Edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks, etc.) may also be utilized in place of or in combination with such 3GPP carrier networks.

The network components of the Edge cloud 310 may be servers, multi-tenant servers, appliance computing devices, and/or any other type of computing devices. For example, the Edge cloud 310 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., electromagnetic interference (EMI), vibration, extreme temperatures, etc.), and/or enable submergibility. Example housings may include power circuitry to provide power for stationary and/or portable implementations, such as alternating current (AC) power inputs, direct current (DC) power inputs, AC/DC converter(s), DC/AC converter(s), DC/DC converter(s), power regulators, transformers, charging circuitry, batteries, wired inputs, and/or wireless power inputs. Example housings and/or surfaces thereof may include or connect to mounting hardware to enable attachment to structures such as buildings, telecommunication structures (e.g., poles, antenna structures, etc.), and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, infrared or other visual thermal sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, rotors such as propellers, etc.) and/or articulating hardware (e.g., robot arms, pivotable appendages, etc.). In some circumstances, the sensors may include any type of input devices such as user interface hardware (e.g., buttons, switches, dials, sliders, microphones, etc.). In some circumstances, example housings include output devices contained in, carried by, embedded therein and/or attached thereto. Output devices may include displays, touchscreens, lights, light-emitting diodes (LEDs), speakers, input/output (I/O) ports (e.g., universal serial bus (USB)), etc. In some circumstances, Edge devices are devices presented in the network for a specific purpose (e.g., a traffic light), but may have processing and/or other capacities that may be utilized for other purposes. Such Edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. D1B. The Edge cloud 310 may also include one or more servers and/or one or more multi-tenant servers. Such a server may include an operating system and implement a virtual computing environment. A virtual computing environment may include a hypervisor managing (e.g., spawning, deploying, commissioning, destroying, decommissioning, etc.) one or more virtual machines, one or more containers, etc. Such virtual computing environments provide an execution environment in which one or more applications and/or other software, code, or scripts may execute while being isolated from one or more other applications, software, code, or scripts.

In FIG. 5, various client endpoints 510 (in the form of mobile devices, computers, autonomous vehicles, business computing equipment, industrial processing equipment) exchange requests and responses that are specific to the type of endpoint network aggregation. For instance, client endpoints 510 may obtain network access via a wired broadband network, by exchanging requests and responses 522 through an on-premise network system 532. Some client endpoints 510, such as mobile computing devices, may obtain network access via a wireless broadband network, by exchanging requests and responses 524 through an access point (e.g., a cellular network tower) 534. Some client endpoints 510, such as autonomous vehicles may obtain network access for requests and responses 526 via a wireless vehicular network through a street-located network system 536. However, regardless of the type of network access, the TSP may deploy aggregation points 542, 544 within the Edge cloud 310 to aggregate traffic and requests. Thus, within the Edge cloud 310, the TSP may deploy various compute and storage resources, such as at Edge aggregation nodes 540, to provide requested content. The Edge aggregation nodes 540 and other systems of the Edge cloud 310 are connected to a cloud or data center 560, which uses a backhaul network 550 to fulfill higher-latency requests from a cloud/data center for websites, applications, database servers, etc. Additional or consolidated instances of the Edge aggregation nodes 540 and the aggregation points 542, 544, including those deployed on a single server framework, may also be present within the Edge cloud 310 or other areas of the TSP infrastructure.

Flowcharts representative of example machine-readable instructions, which may be executed by programmable circuitry (e.g., to cause programmable circuitry) to implement and/or instantiate the defect analysis system 106 of FIG. 2 and/or representative of example operations which may be performed by programmable circuitry to implement and/or instantiate the defect analysis system 106 of FIG. 2, are shown in FIGS. 6, 7, and 8. The machine-readable instructions may be one or more executable programs or portion(s) of one or more executable programs for execution by programmable circuitry such as the programmable circuitry 912 shown in the example programmable circuitry platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowcharts illustrated in FIGS. 6, 7, and 8, many other methods of implementing the example defect analysis system 106 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine-executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine-executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6, 7, and 8 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 6 is a flowchart representative of example machine-readable instructions and/or example operations 600 that may be executed, instantiated, and/or performed by example programmable circuitry to implement the defect analysis system 106 of FIG. 2 to generate a defect-aware timeline for an object. The example machine-readable instructions and/or the example operations 600 of FIG. 6 begin at block 602, at which the object monitoring circuitry 206 detects an object in respective streams of sensor data generated by at least two sensors in an environment. For example, at block 602 the object detection circuitry 218 detects an object in respective streams of sensor data generated by at least two sensors in an environment.

In the illustrated example of FIG. 6, at block 604, the object monitoring circuitry 206 identifies the object in the respective streams of sensor data based on a characteristic of the object. For example, at block 604, the object identification circuitry 220 identifies the object in the respective streams of sensor data as a specific object based on a characteristic (e.g., a barcode) of the object. At block 606, the object monitoring circuitry 206 tracks the object in the respective streams of sensor data to generate at least two streams of detection events for the object. For example, at block 606, the object tracking circuitry 222 tracks the object on a per sensor data stream basis to generate at least a first stream of detection events for the object in a first stream of sensor data and a second stream of detection events for the object in a second stream of sensor data.

In the illustrated example of FIG. 6, at block 608, the object correlation circuitry 210 correlates the at least two streams of detection events to generate a timeline representative of the object in the environment. For example, the object correlation circuitry 210 determines sequential locations of the object in the environment at corresponding times based on the at least two streams of detection events to generate the timeline. In some examples, the object correlation circuitry 210 correlates at least two detections of the object in the environment across the at least two sensors (e.g., across the at least two streams of detection events) as the same detection event. In such examples, the object correlation circuitry 210 consolidates the at least two detections of the object into one detection event.

In the illustrated example of FIG. 6, to determine sequential location of the object in the environment at corresponding times, the object correlation circuitry 210 determines that the object was at a first location in the environment at a first time based on the first stream of detection events. Additionally, for example, the object correlation circuitry 210 determines that the object was at a second location in the environment at a second time based on the second stream of detection events. The object correlation circuitry 210 also correlates the first location, the first time, the second location, and the second time to generate a timeline of detection events of the object in the environment.

For example, each detection event includes a timestamp and corresponding metadata. Example metadata includes information representative of a descriptor of a detection event, a location of a sensor at a time of the detection event, a descriptor of the object (e.g., object ID, object type, object contents, etc.), a descriptor of the environment that the object was exposed to at the time of the detection event, equipment that interacted with the object at the time of the detection event, an agent (e.g., an employee, staff, personnel, etc.) that interacted with the object at the time of the detection event, and other object(s) that interacted with at least one of the equipment or the agent at the time of the detection event. In the example of FIG. 6, at block 610, the defect detection circuitry 214 detects a defect of the object in the respective streams of sensor data to generate at least two streams of defect metadata for the object.

In the illustrated example of FIG. 6, at block 612, the defect-to-object fusion circuitry 216 supplements the timelines with the defect to generate a defect-aware timeline of the object. At block 614, the object monitoring circuitry 206 determines if there is an additional stream of sensor data. Based on (e.g., in response to) the object monitoring circuitry 206 determining that there is an additional stream of sensor data (block 614: YES), the machine-readable instructions and/or the operations 600 return to block 602. Based on (e.g., in response to) the object monitoring circuitry 206 determining that there is not an additional stream of sensor data (block 614: NO), the machine-readable instructions and/or the operations 600 terminate.

FIG. 7 is a flowchart representative of example machine-readable instructions and/or example operations 700 that may be executed, instantiated, and/or performed by example programmable circuitry to implement the defect analysis system 106 of FIG. 2 to allocate an event to a cluster. The example machine-readable instructions and/or the example operations 700 of FIG. 7 begin at block 702, at which the defect-to-object fusion circuitry 216 causes transmission of a query to a database (e.g., the historian database 204) based on an event recorded in a stream of detection events for an object. For example, the event corresponds to a defect in the object.

In the illustrated example of FIG. 7, at block 704, the defect-to-object fusion circuitry 216 accesses, from the database, clusters of similar events. For example, similar events include events that occurred at the time the defect was reported, events that share a defect type with the defect, events that share equipment that interacted with the object at the time the defect was reported, and events that share an agent that interacted with the object at the time the defect was reported. At block 706, the defect-to-object fusion circuitry 216 computes respective levels of correlation between the event and the clusters.

In the illustrated example of FIG. 7, at block 708, the defect-to-object fusion circuitry 216 determines a first cluster of the clusters that has a highest level of correlation among the respective levels of correlation. At block 710, the defect-to-object fusion circuitry 216 allocates the event to the first cluster. As such, the defect-to-object fusion circuitry 216 allocates the event to one of the clusters (e.g., the first cluster) based on correlations between the event and respective ones of the clusters.

In the illustrated example of FIG. 7, at block 712, the defect-to-object fusion circuitry 216 determines if there is an additional event to allocate. Based on (e.g., in response to) the defect-to-object fusion circuitry 216 determining that there is an additional event to allocate (block 712: YES), the machine-readable instructions and/or the operations 700 return to block 712. Based on (e.g., in response to) the defect-to-object fusion circuitry 216 determining that there is not an additional event to allocate (block 712: NO), the machine-readable instructions and/or the operations 700 terminate.

FIG. 8 is a flowchart representative of example machine-readable instructions and/or example operations 800 that may be executed, instantiated, and/or performed by example programmable circuitry to implement the defect analysis system 106 of FIG. 2 to identify a cause of a defect to an object. The example machine-readable instructions and/or the example operations 800 of FIG. 8 begin at block 802, at which the cause analysis circuitry 230 causes transmission of a query to a database (e.g., the historian database 204) based on first metadata of a defect of an object, the object having been present in a first environment. For example, the first metadata of the defect of the object may be a first stream of detection events, a first detection-aware timeline, a defect type of the defect of the object, among others.

In the illustrated example of FIG. 8, at block 804, the cause analysis circuitry 230 accesses, from the database, second metadata that was generated by a first sensor in the first environment within a threshold period of a time associated with the defect. For example, the second metadata includes detection events for the object on the same day that the defect was reported and/or detected. In some examples, where the cause analysis circuitry 230 queries the database based on a defect type of the defect, the cause analysis circuitry 230 accesses second metadata that was generated by a first sensor in the first environment within a threshold period of the time.

In the illustrated example of FIG. 8, at block 806, the cause analysis circuitry 230 accesses, from the database, third metadata that was generated by a second sensor in the first environment before the time associated with the defect. In some examples, where the cause analysis circuitry 230 queries the database based on at least one of a first event, a first time of the first event, a first location associated with the first event, equipment that interacted with the object at the first time, or an agent that interacted with the object at the first time, the cause analysis circuitry 230 accesses third metadata that was generated by a second sensor in the first environment before the time associated with the defect. For example, the third metadata includes at least one detection event stream generated by at least one sensor in the first environment.

In the illustrated example of FIG. 8, at block 808, the cause analysis circuitry 230 accesses, from the database, fourth metadata that was generated by a third sensor in a second environment. For example, the fourth metadata includes at least one detection event stream generated by at least one sensor in the second environment. At block 810, the cause analysis circuitry 230 identifies a cause of the defect based on the first metadata and at least one of the second metadata, the third metadata, or the fourth metadata. At block 812, the cause analysis circuitry 230 determines if there is an additional defect. Based on (e.g., in response to) the cause analysis circuitry 230 determining that there is an additional defect (block 812: YES), the machine-readable instructions and/or the operations 800 return to block 802. Based on (e.g., in response to) the cause analysis circuitry 230 determining that there is not an additional defect (block 812: NO), the machine-readable instructions and/or the operations 800 terminate.

FIG. 9 is a block diagram of an example programmable circuitry platform 900 structured to execute and/or instantiate the example machine-readable instructions and/or the example operations of FIGS. 6, 7, and/or 8 to implement the defect analysis system 106 of FIG. 2. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements the example object monitoring circuitry 206, the example object correlation circuitry 210, the example defect detection circuitry 214, the example defect-to-object fusion circuitry 216, the example object detection circuitry 218, the example object identification circuitry 220, the example object tracking circuitry 222, the example visualizer circuitry 224, the example clustering and correlation circuitry 228, the example cause analysis circuitry 230, the example cost analysis circuitry 232, and/or the example sensor correlation circuitry 234.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc. In this example, the interface circuitry 920 implements the example receiver circuitry 202 and/or the example transmitter circuitry 226.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In this example, the one or more mass storage discs or devices 928 implement the example historian database 204, the example object identification database 208, and/or the example sensor correlation parameter database 212.

The machine-readable instructions 932, which may be implemented by the machine-readable instructions of FIGS. 6, 7, and/or 8, may be stored in the mass storage device 928, in the volatile memory 914, in the non-volatile memory 916, and/or on at least one non-transitory computer-readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 executes some or all of the machine-readable instructions of the flowcharts of FIGS. 6, 7, and/or 8 to effectively instantiate the circuitry of FIG. 2 as logic circuits to perform operations corresponding to those machine-readable instructions. In some such examples, the circuitry of FIG. 2 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine-readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine-readable instructions and/or operations represented by the flowcharts of FIGS. 6, 7, and/or 8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry 1016 (sometimes referred to as an ALU), a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating-point operations. In yet other examples, the AL circuitry 1016 may include first AL circuitry that performs integer-based operations and second AL circuitry that performs floating-point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure, such as by being distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

FIG. 11 is a block diagram of another example implementation of the programmable circuitry 912 of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine-readable instructions. However, once configured, the FPGA circuitry 1100 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine-readable instructions represented by the flowcharts of FIGS. 6, 7, and/or 8 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine-readable instructions represented by the flowcharts of FIGS. 6, 7, and/or 8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 6, 7, and/or 8. As such, the FPGA circuitry 1100 may be configured and/or structured to effectively instantiate some or all of the operations/functions corresponding to the machine-readable instructions of the flowcharts of FIGS. 6, 7, and/or 8 as dedicated logic circuits to perform the operations/functions corresponding to those software instructions in a dedicated manner analogous to an ASIC. Therefore, the FPGA circuitry 1100 may perform the operations/functions corresponding to the some or all of the machine-readable instructions of FIGS. 6, 7, and/or 8 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine-readable instructions of FIGS. 6, 7, and/or 8 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 10. Therefore, the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1002 of FIG. 10 may execute a first portion of the machine-readable instructions represented by the flowcharts of FIGS. 6, 7, and/or 8 to perform first operation(s)/function(s), the FPGA circuitry 1100 of FIG. 11 may be configured and/or structured to perform second operation(s)/function(s) corresponding to a second portion of the machine-readable instructions represented by the flowcharts of FIGS. 6, 7, and/or 8, and/or an ASIC may be configured and/or structured to perform third operation(s)/function(s) corresponding to a third portion of the machine-readable instructions represented by the flowcharts of FIGS. 6, 7, and/or 8.

It should be understood that some or all of the circuitry of FIG. 2 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1000 of FIG. 10 may execute machine-readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIG. 2 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 912 of FIG. 9, which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

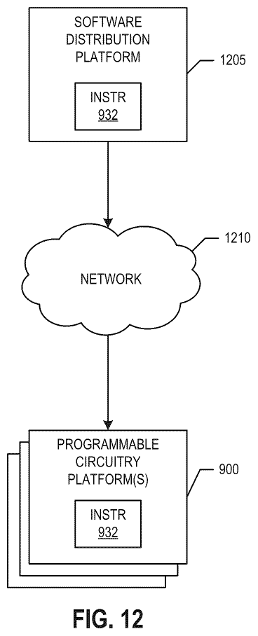

A block diagram illustrating an example software distribution platform 1205 to distribute software such as the example machine-readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine-readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine-readable instructions 932, which may correspond to the example machine-readable instructions of FIGS. 6, 7, and/or 8, as described above. The one or more servers of the example software distribution platform 1205 are in communication with an example network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 932 from the software distribution platform 1205. For example, the software, which may correspond to the example machine-readable instructions of FIGS. 6, 7, and/or 8, may be downloaded to the example programmable circuitry platform 900, which is to execute the machine-readable instructions 932 to implement the defect analysis system 106. In some examples, one or more servers of the software distribution platform 1205 periodically offer, transmit, and/or force updates to the software (e.g., the example machine-readable instructions 932 of FIG. 9) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that identify causes of defects in industrial environments. Disclosed systems, apparatus, articles of manufacture, and methods provide a holistic view of defects detected in an industrial environment and track the defects across multiple sensor streams over time. As such, disclosed examples track an object over time and space, identify a source of a defect, and provide a view of available sensor data relevant to a defective object, even when a given sensor input cannot observe the defect. Additionally, examples disclosed herein provide implicit sensor data collection to facilitate root cause analysis of defects detected in industrial environments.

Accordingly, disclosed examples correlate two or more events and analyze the resulting costs of defects that may be caused by the events. As such, examples disclosed herein identify sources of risk in industrial environments and determine adjustment to industrial processes to improve the industrial processes. Disclosed systems, apparatus, articles of manufacture, and methods improve the efficiency of using a computing device by proactively identifying damaged equipment and/or damaging conditions in industrial environments and alerting management of and/or causing remediation of the damaged equipment and/or damaging conditions. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to identify causes of defects in industrial environments are disclosed herein. Further examples and combinations thereof include the following:

Example 1 includes an apparatus comprising interface circuitry to access data associated with an object in an environment, machine-readable instructions, and programmable circuitry to utilize the machine-readable instructions to identify a cause of a defect of the object based on a timeline of the object in the environment, the timeline based on the data.

Example 2 includes the apparatus of example 1, wherein the data includes first data from a first sensor and second data from a second sensor, and the programmable circuitry is to determine that the object was at a first location in the environment at a first time based on the first data, determine that the object was at a second location in the environment at a second time based on the second data, and generate the timeline based on the first location, the first time, the second location, and the second time.

Example 3 includes the apparatus of any of examples 1 or 2, wherein the interface circuitry is to communicate with a sensor in the environment to access the data, and the programmable circuitry is to cause equipment in the environment to perform an action based on the cause of the defect.

Example 4 includes the apparatus of any of examples 1, 2, or 3, wherein the data includes information representative of at least one of a descriptor of an event, a time of the event, a location of a sensor at the time of the event, equipment that interacted with the object at the time of the event, or an agent that interacted with the object at the time of the event.

Example 5 includes the apparatus of any of examples 1, 2, 3, or 4, wherein the data is first data, and the programmable circuitry is to obtain second data generated by a sensor within a threshold period of a time the defect of the object was reported, the second data based on a type of the defect, and identify the cause of the defect based on the first data and the second data.

Example 6 includes the apparatus of any of examples 1, 2, 3, 4, or 5, wherein the data is first data including first information, and the programmable circuitry is to obtain second data based on first information represented in the first data, the first information including at least one of a first event, a first time of the first event, a first location associated with the first event, equipment that interacted with the object at the first time, or an agent that interacted with the object at the first time, the second data including second information representative of a second event that occurred at a second time before the first time, and identify the cause of the defect based on the first data and the second data.

Example 7 includes the apparatus of any of examples 1, 2, 3, 4, 5, or 6, wherein the environment is a first environment, the data is first data, and the programmable circuitry is to obtain second data associated with a second environment based on a type of the defect, and identify the cause of the defect based on the first data and the second data.

Example 8 includes the apparatus of any of examples 1, 2, 3, 4, 5, 6, or 7, wherein the data is first data, the defect is associated with a time, and the programmable circuitry is to identify an event recorded in the first data, the event associated with the time, access clusters of events, respective ones of the clusters corresponding to the time, a defect type of the defect, equipment that interacted with the object at the time, or an agent that interacted with the object at the time, and allocate the event to one of the clusters based on correlations between the event and the respective ones of the clusters.

Example 9 includes a non-transitory machine-readable storage medium comprising machine-readable instructions to cause programmable circuitry to at least identify a cause of a defect of an object based on a timeline of the object in an environment, the timeline based on data associated with the object.

Example 10 includes the non-transitory machine-readable storage medium of example 9, wherein the data includes first data from a first sensor and second data from a second sensor, and the machine-readable instructions cause the programmable circuitry to determine that the object was at a first location in the environment at a first time based on the first data, determine that the object was at a second location in the environment at a second time based on the second data, and generate the timeline based on the first location, the first time, the second location, and the second time.

Example 11 includes the non-transitory machine-readable storage medium of any of examples 9 or 10, wherein the data includes information representative of at least one of a descriptor of an event, a time of the event, a location of a sensor at the time of the event, equipment that interacted with the object at the time of the event, or an agent that interacted with the object at the time of the event.

Example 12 includes the non-transitory machine-readable storage medium of any of examples 9, 10, or 11, wherein the data is first data, and the machine-readable instructions cause the programmable circuitry to obtain second data generated by a sensor within a threshold period of a time the defect of the object was reported, the second data based on a type of the defect, and identify the cause of the defect based on the first data and the second data.

Example 13 includes the non-transitory machine-readable storage medium of any of examples 9, 10, 11, or 12, wherein the data is first data including first information, and the machine-readable instructions cause the programmable circuitry to obtain second data based on first information represented in the first data, the first information including at least one of a first event, a first time of the first event, a first location associated with the first event, equipment that interacted with the object at the first time, or an agent that interacted with the object at the first time, the second data including second information representative of a second event that occurred at a second time before the first time, and identify the cause of the defect based on the first data and the second data.

Example 14 includes the non-transitory machine-readable storage medium of any of examples 9, 10, 11, 12, or 13, wherein the environment is a first environment, the data is first data, and the machine-readable instructions cause the programmable circuitry to obtain second data associated with a second environment based on a type of the defect, and identify the cause of the defect based on the first data and the second data.

Example 15 includes the non-transitory machine-readable storage medium of any of examples 9, 10, 11, 12, 13, or 14, wherein the data is first data, the defect is associated with a time, and the machine-readable instructions cause the programmable circuitry to identify an event recorded in the first data, the event associated with the time, access clusters of events, respective ones of the clusters corresponding to the time, a defect type of the defect, equipment that interacted with the object at the time, or an agent that interacted with the object at the time, and allocate the event to one of the clusters based on correlations between the event and the respective ones of the clusters.

Example 16 includes a method comprising accessing data associated with an object in an environment, and identifying, by utilizing an instruction with programmable circuitry, a cause of a defect of the object based on a timeline of the object in the environment, the timeline based on the data.

Example 17 includes the method of example 16, wherein the data includes first data from a first sensor and second data from a second sensor, and the method further includes determining that the object was at a first location in the environment at a first time based on the first data, determining that the object was at a second location in the environment at a second time based on the second data, and generating the timeline based on the first location, the first time, the second location, and the second time.

Example 18 includes the method of any of examples 16 or 17, wherein the data is first data, and the method further includes obtaining second data generated by a sensor within a threshold period of a time the defect of the object was reported, the second data based on a type of the defect, and identifying the cause of the defect based on the first data and the second data.

Example 19 includes the method of any of examples 16, 17, or 18, wherein the data is first data including first information, and the method further includes obtaining second data based on first information represented in the first data, the first information including at least one of a first event, a first time of the first event, a first location associated with the first event, equipment that interacted with the object at the first time, or an agent that interacted with the object at the first time, the second data including second information representative of a second event that occurred at a second time before the first time, and identifying the cause of the defect based on the first data and the second data.

Example 20 includes the method of any of examples 16, 17, 18, or 19, wherein the environment is a first environment, the data is first data, and the method further includes obtaining second data associated with a second environment based on a type of the defect, and identifying the cause of the defect based on the first data and the second data.

Example 21 includes the method of any of examples 16, 17, 18, 19, or 20, wherein the data is first data, the defect is associated with a time, and the method further includes identifying an event recorded in the first data, the event associated with the time, accessing clusters of events, respective ones of the clusters corresponding to the time, a defect type of the defect, equipment that interacted with the object at the time, or an agent that interacted with the object at the time, and allocating the event to one of the clusters based on correlations between the event and the respective ones of the clusters.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry to access data associated with an object in an environment;
machine-readable instructions; and
programmable circuitry to utilize the machine-readable instructions to identify a cause of a defect of the object based on a timeline of the object in the environment, the timeline based on the data.

2. The apparatus of claim 1, wherein the data includes first data from a first sensor and second data from a second sensor, and the programmable circuitry is to:
determine that the object was at a first location in the environment at a first time based on the first data;
determine that the object was at a second location in the environment at a second time based on the second data; and
generate the timeline based on the first location, the first time, the second location, and the second time.

3. The apparatus of claim 1, wherein:
the interface circuitry is to communicate with a sensor in the environment to access the data; and
the programmable circuitry is to cause equipment in the environment to perform an action based on the cause of the defect.

4. The apparatus of claim 1, wherein the data includes information representative of at least one of a descriptor of an event, a time of the event, a location of a sensor at the time of the event, equipment that interacted with the object at the time of the event, or an agent that interacted with the object at the time of the event.

5. The apparatus of claim 1, wherein the data is first data, and the programmable circuitry is to:
obtain second data generated by a sensor within a threshold period of a time the defect of the object was reported, the second data based on a type of the defect; and
identify the cause of the defect based on the first data and the second data.

6. The apparatus of claim 1, wherein the data is first data including first information, and the programmable circuitry is to:
obtain second data based on first information represented in the first data, the first information including at least one of a first event, a first time of the first event, a first location associated with the first event, equipment that interacted with the object at the first time, or an agent that interacted with the object at the first time, the second data including second information representative of a second event that occurred at a second time before the first time; and
identify the cause of the defect based on the first data and the second data.

7. The apparatus of claim 1, wherein the environment is a first environment, the data is first data, and the programmable circuitry is to:
obtain second data associated with a second environment based on a type of the defect; and
identify the cause of the defect based on the first data and the second data.

8. The apparatus of claim 1, wherein the data is first data, the defect is associated with a time, and the programmable circuitry is to:
identify an event recorded in the first data, the event associated with the time;
access clusters of events, respective ones of the clusters corresponding to the time, a defect type of the defect, equipment that interacted with the object at the time, or an agent that interacted with the object at the time; and
allocate the event to one of the clusters based on correlations between the event and the respective ones of the clusters.

9. A non-transitory machine-readable storage medium comprising machine-readable instructions to cause programmable circuitry to at least identify a cause of a defect of an object based on a timeline of the object in an environment, the timeline based on data associated with the object.

10. The non-transitory machine-readable storage medium of claim 9, wherein the data includes first data from a first sensor and second data from a second sensor, and the machine-readable instructions cause the programmable circuitry to:
determine that the object was at a first location in the environment at a first time based on the first data;
determine that the object was at a second location in the environment at a second time based on the second data; and
generate the timeline based on the first location, the first time, the second location, and the second time.

11. The non-transitory machine-readable storage medium of claim 9, wherein the data includes information representative of at least one of a descriptor of an event, a time of the event, a location of a sensor at the time of the event, equipment that interacted with the object at the time of the event, or an agent that interacted with the object at the time of the event.

12. The non-transitory machine-readable storage medium of claim 9, wherein the data is first data, and the machine-readable instructions cause the programmable circuitry to:
obtain second data generated by a sensor within a threshold period of a time the defect of the object was reported, the second data based on a type of the defect; and
identify the cause of the defect based on the first data and the second data.

13. The non-transitory machine-readable storage medium of claim 9, wherein the data is first data including first information, and the machine-readable instructions cause the programmable circuitry to:
obtain second data based on first information represented in the first data, the first information including at least one of a first event, a first time of the first event, a first location associated with the first event, equipment that interacted with the object at the first time, or an agent that interacted with the object at the first time, the second data including second information representative of a second event that occurred at a second time before the first time; and
identify the cause of the defect based on the first data and the second data.

14. The non-transitory machine-readable storage medium of claim 9, wherein the environment is a first environment, the data is first data, and the machine-readable instructions cause the programmable circuitry to:
obtain second data associated with a second environment based on a type of the defect; and
identify the cause of the defect based on the first data and the second data.

15. The non-transitory machine-readable storage medium of claim 9, wherein the data is first data, the defect is associated with a time, and the machine-readable instructions cause the programmable circuitry to:
identify an event recorded in the first data, the event associated with the time;
access clusters of events, respective ones of the clusters corresponding to the time, a defect type of the defect, equipment that interacted with the object at the time, or an agent that interacted with the object at the time; and
allocate the event to one of the clusters based on correlations between the event and the respective ones of the clusters.

16. A method comprising:
accessing data associated with an object in an environment; and
identifying, by utilizing an instruction with programmable circuitry, a cause of a defect of the object based on a timeline of the object in the environment, the timeline based on the data.

17. The method of claim 16, wherein the data includes first data from a first sensor and second data from a second sensor, and the method further includes:
determining that the object was at a first location in the environment at a first time based on the first data;
determining that the object was at a second location in the environment at a second time based on the second data; and
generating the timeline based on the first location, the first time, the second location, and the second time.

18. The method of claim 16, wherein the data is first data, and the method further includes:
obtaining second data generated by a sensor within a threshold period of a time the defect of the object was reported, the second data based on a type of the defect; and
identifying the cause of the defect based on the first data and the second data.

19. The method of claim 16, wherein the data is first data including first information, and the method further includes:
obtaining second data based on first information represented in the first data, the first information including at least one of a first event, a first time of the first event, a first location associated with the first event, equipment that interacted with the object at the first time, or an agent that interacted with the object at the first time, the second data including second information representative of a second event that occurred at a second time before the first time; and
identifying the cause of the defect based on the first data and the second data.

20. The method of claim 16, wherein the environment is a first environment, the data is first data, and the method further includes:
obtaining second data associated with a second environment based on a type of the defect; and
identifying the cause of the defect based on the first data and the second data.
